(19) United States
(12) Patent Application Publication
(10) Pub. No.: US 2025/0048366 A1
(43) Pub. Date: Feb. 6, 2025

(54) MANAGING SMALL DATA COMMUNICATION

(71) Applicant: GOOGLE LLC, Mountain View, CA (US)

(72) Inventor: Chih-Hsiang Wu, Taoyuan City (TW)

(21) Appl. No.: 18/716,381

(22) PCT Filed: Jan. 6, 2023
(86) PCT No.: PCT/US23/10265

§ 371 Date: Jun. 4, 2024

Related U.S. Application Data
(60) Provisional application No. 63/344,689, filed on May 23, 2022.
(60) Provisional application No. 63/297,223, filed on Jan. 6, 2022.

(51) Int. Cl. H04W 72/21; H04W 28/02; H04W 88/08

(52) U.S. Cl. CPC H04W 72/21; H04W 28/0263; H04W 88/085

(57) ABSTRACT

A method, for transferring uplink data that includes control-plane or non-control plane information to a central unit (CU), is implemented by a distributed unit (DU) of a base station. The method includes receiving, from a user equipment (UE) in an inactive state, the uplink data via a logical channel, determining, based on the logical channel, whether to transmit the uplink data via a transport network layer protocol stack or in an uplink radio resource control (RRC) message transfer message, and transmitting the uplink data to the CU in accordance with the determining.

### FIELD OF THE DISCLOSURE

This disclosure relates generally to wireless communications and, more particularly, to communication of uplink and/or downlink data at a user equipment (UE) and a distributed unit (DU) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating in a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state using RAN-level base station coordination and RAN-level paging procedures. In some cases, the UE in the RRC_INACTIVE state has only one, relatively small packet to transmit. For situations such as these, 3GPP is discussing a Small Data Transmission (SDT) procedure to enable the 5G NR to support data transmission for the UE operating in the RRC_INACTIVE state (i.e., without requiring that the UE transition to the RRC_CONNECTED state).

SDT is enabled on a radio bearer basis and is initiated by the UE only if less than a configured amount of uplink data awaits transmission across all radio bearers for which SDT is enabled, the downlink (DL) reference signal received power (RSRP) is above a configured threshold, and a valid SDT resource is available. An SDT procedure can be initiated by the UE with either a transmission over a random access channel (RACH), i.e., random access SDT (RA-SDT) or over Type 1 configured grant (CG) resources, i.e., CG-SDT. For the RA-SDT, the network configures 2-step and/or 4-step random access resources for SDT. In the RA-SDT, the UE can transmit an initial transmission including data in a message 3 (MSG3) of a 4-step random access procedure or in payload of a message A (MSGA) of a 2-step random access procedure. The network can then schedule subsequent uplink and/or downlink transmissions using dynamic uplink grants and downlink assignments, respectively, after completion of the random access procedure.

The CG-SDT can only be initiated with valid uplink (UL) timing alignment. The EU maintains the UL timing alignment based on a network-configured, SDT-specific timing alignment timer and DL RSRP of a configured number of highest ranked SSBs. Upon expiry of the SDT-specific timing alignment timer, the CG resources are released. Upon initiating the CG-SDT, the UE transmits an initial transmission including data on a CG occasion using a CG configuration, and the network can schedule subsequent uplink transmissions using dynamic grants or on future CG resource occasions. During the CG-SDT, the downlink transmissions are scheduled using dynamic assignments. The UE can initiate subsequent uplink transmission only after receiving, from the network, confirmation for the initial uplink transmission.

In some scenarios, the UE may connect to a 5G NR radio access network (NG-RAN) that includes base stations each having a central unit (CU) and at least one distributed unit (DU). However, it is not clear how a base station including a CU and a DU should perform SDT with the UE.

### SUMMARY

According to certain techniques of this disclosure, a base station can determine to transition a UE that has been communicating with the base station in SDT operation from an inactive state to a connected state (i.e., to enable non-SDT communication). The base station may determine to transition the UE to the connected state based on a request or notification from the UE (e.g., an indication that the UE has non-SDT uplink data available for transmission), or when the base station receives non-SDT downlink data from the core network, for example.

When determining to transition the UE in this manner, the base station can perform a UE context procedure to obtain a non-SDT configuration for the UE. For example, a CU of a distributed base station may send a UE context request message to the DU that has been communicating with the UE, and the DU may respond by sending the CU a UE context response message that includes a non-SDT DU configuration. The CU can then send a message including the non-SDT DU configuration and a non-SDT CU configuration to the UE via the DU (e.g., with the DU forwarding the non-SDT configurations within an RRC resume message).

According to another technique of this disclosure, a CU of a distributed base station can process an information element of an interface message from the DU (i.e., a DU-to-CU message) based on an SRB identity within the interface message, in order to obtain an RRC message. In particular, if the SRB identity is zero, the CU may determine that an octet string within the information element is a UL-CCCH message, and extract the RRC message from the UL-CCCH message. If the SRB identity is not zero (e.g., is one or two), however, the CU may determine that the octet string is a PDCP PDU. In this latter case, the CU may process (e.g., decrypt a portion of) the PDCP PDU to obtain a UL-DCCH message, and extract the RRC message from the UL-DCCH message.

According to other techniques of this disclosure, a DU of a distributed base station can determine how to transfer a UL data packet to a CU based on a logical channel via which the DU receives the UL data packet from a UE, and/or based on whether the DU receives the UL data packet via configured grant radio resources. For example, the DU may use both of these factors to determine whether to transmit the UL data packet via a transport network layer protocol stack, in a (non-initial) UL RRC Message Transfer message, or in an Initial UL RRC Message Transfer message.

As used herein, and unless a more specific meaning is clear from the context of use, the term “data” or “data packet” can refer to signaling, control-plane information at a protocol layer of controlling radio resources (e.g., RRC), controlling mobility management (MM), or controlling session management (SM), or can refer to non-signaling, non-control-plane information at a protocol layer above the layer of the protocol for controlling radio resources (e.g., RRC), above the layer of the protocol for controlling MM, above the layer of the protocol for controlling SM, and/or above the layer of the protocol for controlling quality of service (QOS) flows (e.g., service data adaptation protocol (SDAP)). The data to which the UE and/or the RAN applies the techniques of this disclosure can include, for example, Internet of things (IoT) data, Ethernet traffic data, Internet traffic data, or a short message service (SMS) message, for example. Further, the UE in some implementations applies SDT techniques only if the size of the data is below a certain (e.g., configured) threshold value. It is also understood that, as used herein (and unless the context of its use indicates a more specific meaning), the term “configuration” can refer to a full configuration, or to a subset of parameters of a full configuration (e.g., a “delta” or other partial configuration that can augment an existing configuration without completely replacing the existing configuration.

In some examples, a method for transferring uplink data that includes control plane or non-control plane information to a CU is implemented by a DU of a base station. The method includes receiving, from a UE in an inactive state, the uplink data via a logical channel, determining, based on the logical channel, whether to transmit the uplink data via a transport network layer protocol stack or in an uplink RRC message transfer message, and transmitting the uplink data to the CU in accordance with the determining.

In other examples, a method for obtaining an RRC message from an interface message is implemented by a CU of a base station. The method includes receiving, from a DU of the base station, a DU-to-CU message that includes an SRB identity and an octet string, determining, based on the SRB identifier, whether the octet string is a PDCP PDU or a UL-CCCH message, and processing, based on the determining, the PDCP PDU or the UL-CCCH to obtain the RRC message.

In other examples, a method for transferring uplink data that includes control plane or non-control plane information to a CU is implemented by a DU of a base station. The method includes receiving, from a UE in an inactive state, the uplink data via radio resources, determining, based on whether the radio resources are configured grant radio resources, whether to transmit the uplink data in an initial uplink RRC message transfer message or a non-initial uplink RRC message transfer message, and transmitting the uplink data to the CU in accordance with the determining.

In other examples, a RAN node includes processing hardware and is configured to perform any one of the example methods above.

### BRIEF DESCRIPTION OF THE DRAWINGS

FIG. 1A is a block diagram of an example wireless communication system in which a user device and a base station of this disclosure can implement the techniques of this disclosure;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a messaging diagram of an example procedure for obtaining a non-SDT configuration for communicating data packets between a UE and a distributed base station when a radio connection between the UE and the base station is active, and for obtaining an SDT configuration for communicating data packets between the UE and the distributed base station when the radio connection between the UE and the base station is inactive;

FIG. 4 is a messaging diagram of an example procedure for communicating data packets between a UE and a distributed base station when a radio connection between the UE and the base station is inactive;

FIG. 5 is a messaging diagram of an example scenario in which a distributed base station transitions a UE that is in an inactive state, and performing small data communication with the base station, to a connected state;

FIG. 6 is a flow diagram of an example method, which can be implemented in the CU or CU-CP of FIG. 1B, for processing an information element of an interface message to obtain an RRC message;

FIG. 7 is a flow diagram of an example method, which can be implemented in the DU of FIG. 1B, for transferring a UL data packet to a CU;

FIGS. 8-10 are flow diagrams of example methods, which can be implemented in the base station of FIG. 1A (e.g., the CU or DU of FIG. 1B), for transitioning a UE that is in an inactive state, and performing small data communication with the base station, to a connected state;

FIG. 11 is a flow diagram of an example method, which can be implemented in the UE of FIG. 1A, for transitioning the UE from an inactive state in which the UE performs small data communication with a base station to a connected state;

FIG. 12 is a flow diagram of another example method, which can be implemented by a DU of FIG. 1B, for transferring a UL data packet to a CU of FIG. 1B.

### DETAILED DESCRIPTION OF THE DRAWINGS

As discussed in more detail below, a user equipment (UE) and/or a network node of a radio access network (RAN) can use the techniques of this disclosure for managing small data communication and transitioning a UE between states of a protocol for controlling radio resources between the UE and the RAN. As used in this disclosure, small data communication can refer to small data transmission (SDT) from the perspective of the network (i.e., SDT in the downlink direction), or SDT from the perspective of the UE (i.e., SDT in the uplink direction).

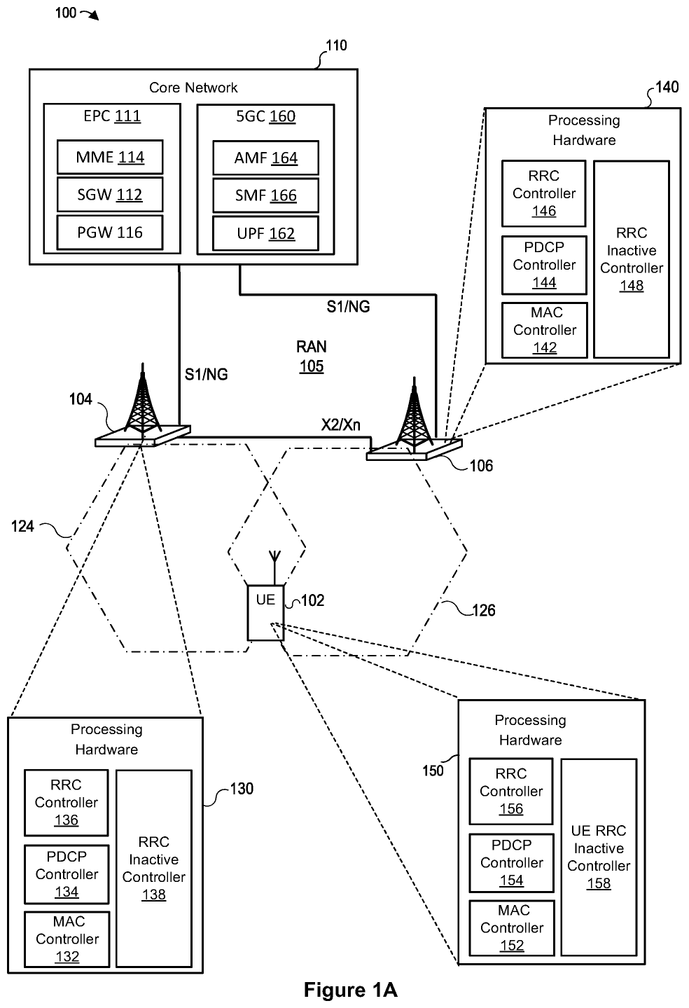

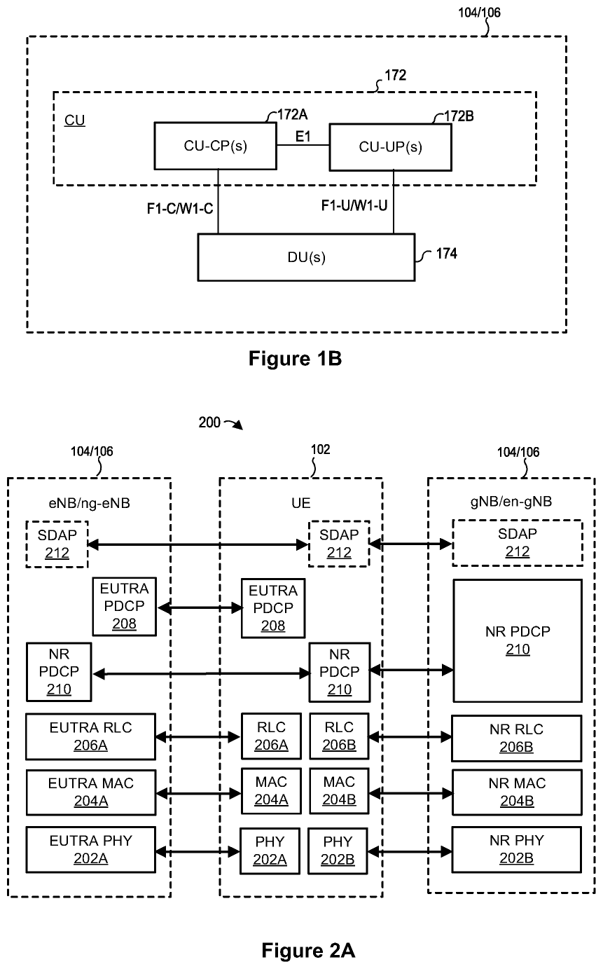

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

The CN 110 may also communicatively connect the UE 102 to an IMS network 170, via the RAN 105. The IMS network 170 can provide to the UE 102 various IMS services, such as IMS short messages, IMS unstructured supplementary service data (USSD), IMS value added service data, IMS supplementary service data, IMS voice calls, and IMS video calls. To this end, an entity (e.g., a server or a group of servers) operating in the IMS network 170 supports packet exchange with the UE. The packets can convey signaling (such as session initiation protocol (SIP) messages, IP messages, or other suitable messages) as well as data (“or media”) such as voice or video.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol. As discussed below, the UE 102 in some implementations applies the techniques of this disclosure only if the size of the data (e.g., UL data) is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to an uplink (UL) data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In this latter case, the UE 102 may omit a UE ID of the UE 102 from the UL MAC PDU that does not include a UL RRC message. In yet further implementations, the UE 102 can include the UL PDCP PDU in a UL radio link control (RLC) PDU and then include the UL RLC PDU in the UL MAC PDU. In some implementation in which the UL RRC message is included in the UL MAC PDU, the UE 102 generates an RRC MAC-I and includes the RRC MAC-I in the UL RRC message. For example, the RRC MAC-I may be a resumeMAC-I field, as specified in 3GPP specification 38.331. In further implementations, the UE can obtain the RRC MAC-I from the UL RRC message with an integrity key (e.g., KRRCint key), an integrity protection algorithm, and the parameters COUNT (e.g., 32-bit, 64-bit or 128-bit value), BEARER (e.g., 5-bit value) and DIRECTION (e.g., 1-bit value).

In further implementations, the data is a UL SDU of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. The UE 102 can then include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In such scenarios, the base station 106 can be referred as the “anchor” base station that sent the UE 102 into the inactive state while retaining the full UE context information. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. The UE 102 then confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction in some scenarios, and receive UL PDCP PDUs in accordance with which the base station 104 can receive data in the uplink direction in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to transmit DL PDCP PDUs in accordance with which the base station 106 can transmit data in the downlink direction in some scenarios, and receive UL PDCP PDUs in accordance with which the base station 106 can receive data in the uplink direction in other scenarios. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

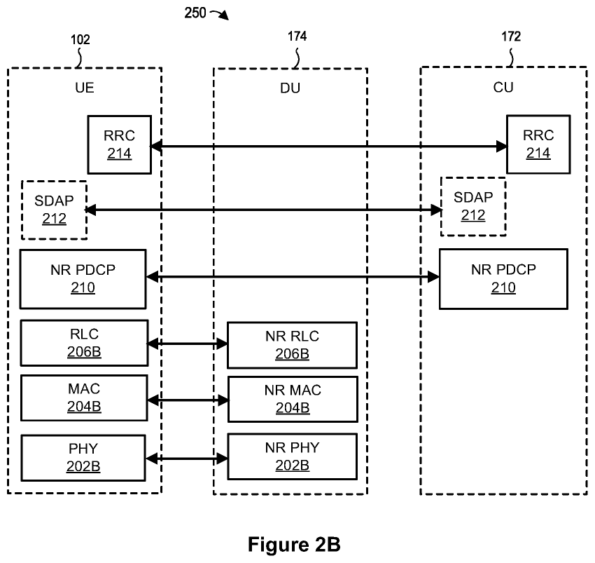

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, IP packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

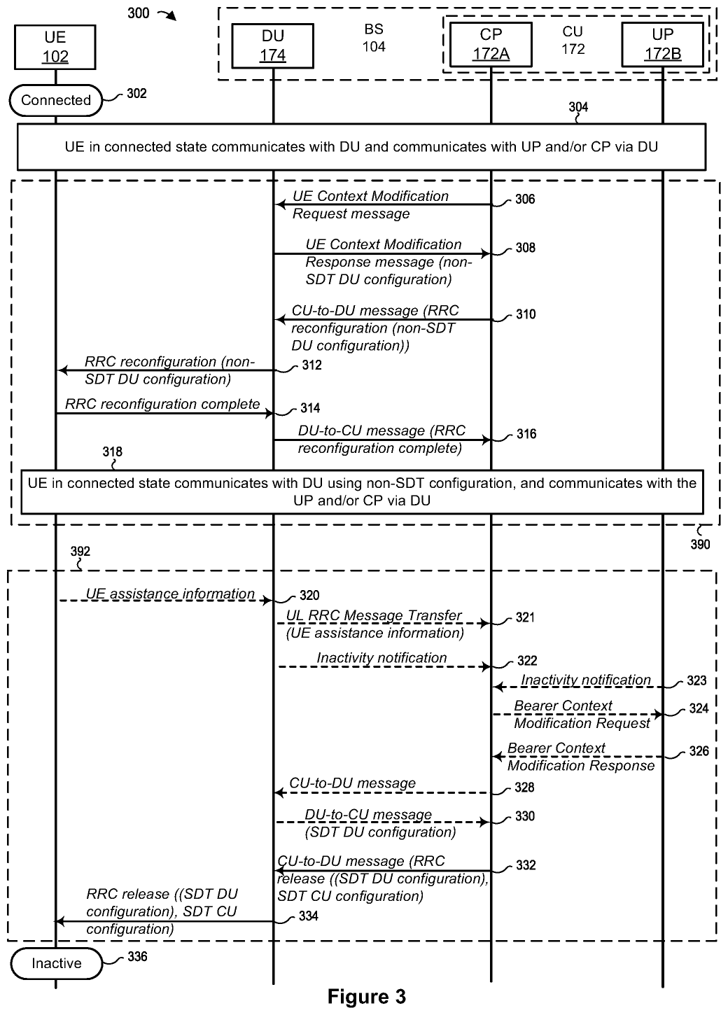

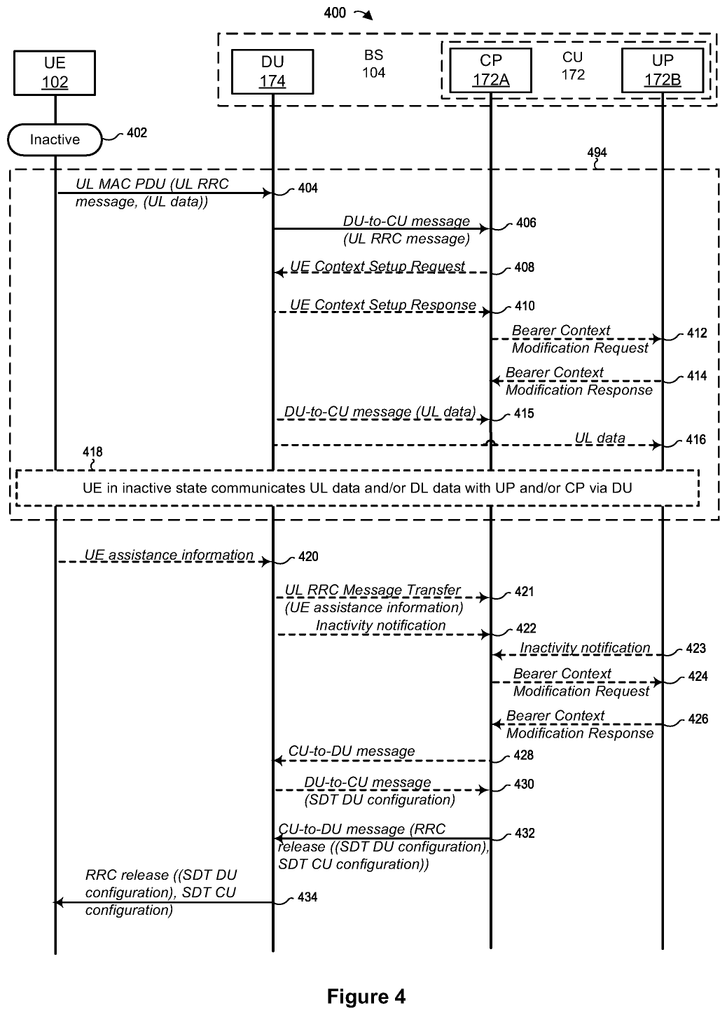

Next, several example scenarios that involve several components of FIG. 1A and relate to transmitting data in an inactive or idle state are discussed next with reference to FIGS. 3 and 4. To simplify the following description, the term “inactive state” is used and can represent the RRC_INACTIVE or RRC_IDLE state, and the term “connected state” is used and can represent the RRC_CONNECTED state.

Referring first to FIG. 3, in a scenario 300, the base station 104 includes a central unit (CU) 172 and a distributed unit (DU) 174 and the CU 172 includes a CU-CP 172A and a CU-UP 172B. In this scenario 300, the UE 102 initially operates in a connected state 302 and communicates 304 with the DU 174 using a DU configuration (i.e., a first non-SDT DU configuration), and communicates 304 with the CU-CP 172A and/or CU-UP 172B via the DU 174 using a CU configuration (i.e., a first non-SDT CU configuration). While the UE communicates 304 with the base station 104, the CU-CP 172A can send 306 a UE Context Modification Request message to the DU 174. In response, the DU 174 sends 308 a UE Context Modification Response message including a non-SDT DU configuration (i.e., a second non-SDT DU configuration) for the UE 102 to the CU-CP 172A. The CU-CP 172A generates an RRC reconfiguration message including the second non-SDT DU configuration and transmits 310 a first CU-to-DU message (e.g., DL RRC Message Transfer message) including the RRC reconfiguration message to the DU 174. In turn, the DU 174 transmits 312 the RRC reconfiguration message to the UE 102. In response, the UE 102 transmits 314 an RRC reconfiguration complete message to the DU 174, which in turn transmits 316 a first DU-to-CU message (e.g., UL RRC Message Transfer message) including the RRC reconfiguration complete message to the CU-CP 172A.

After receiving 312 the RRC reconfiguration message, the UE 102 in the connected state communicates 318 with the DU 174 using the second non-SDT DU configuration and communicates with the CU-CP 172A and/or CU-UP 172B via the DU 174. In cases where the RRC reconfiguration message does not include a CU configuration, the UE 102 communicates 318 with the CU-CP 172A and/or CU-UP 172B via the DU 174 using the first non-SDT CU configuration. In cases where the RRC reconfiguration message includes a non-SDT CU configuration (i.e., a second non-SDT CU configuration), the UE 102 communicates 318 with the CU-CP 172A and/or CU-UP 172B via the DU 174, using the second non-SDT CU configuration. In some implementations, the second non-SDT CU configuration can augment the first non-SDT CU configuration or include at least one new configuration parameter not included in the first non-SDT CU configuration. In such cases, the UE 102 and the CU-CP 172A and/or the CU-UP 172B can communicate 318 with one another using the second non-SDU CU configuration, and also the configuration parameters in the first non-SDT CU configuration that were not augmented by the second non-SDU CU configuration. In some implementations, the first non-SDT CU configuration includes configuration parameters, related to operations of RRC and/or PDCP protocol layers (e.g., RRC 214 and/or NR PDCP 210), that the UE 102 and CU 172 use to communicate with one another while the UE 102 operates in the connected state. Similarly, the second non-SDT CU configuration can include configuration parameters, related to operations of the RRC and/or PDCP protocol layers, that the UE 102 and CU 172 use to communicate with one another while the UE 102 operates in the connected state. In some implementations, the first non-SDT CU configuration includes configuration parameters in a RadioBearerConfig information element (IE) and/or MeusConfig IE defined in 3GPP specification 38.331 v16.7.0. Similarly, the second non-SDT CU configuration includes configuration parameters in the RadioBearerConfig IE and/or MeasConfig IE defined in 3GPP specification 38.331 v16.7.0. In some implementations, the first non-SDT CU configuration can be or include a RadioBearerConfig IE and/or a MeusConfig IE, and the second non-SDT CU configuration can be or include a RadioBearerConfig IE and/or MeasConfig IE.

In some implementations, the second non-SDT DU configuration can augment the first non-SDT DU configuration or include at least one new configuration parameter not included in the first non-SDT DU configuration. In such cases, the UE 102 and the DU 174 can communicate 318 with one another using the second non-SDU DU configuration, and also the configuration parameters in the first non-SDT DU configuration that were not augmented by the second non-SDU DU configuration. In some implementations, the first non-SDT DU configuration includes configuration parameters, related to operations of RRC, RLC, MAC, and/or PHY protocol layers (e.g., RLC 206B, MAC 204B and/or PHY 202B), that the UE 102 and DU 174 use to communicate with one another while the UE 102 operates in the connected state. Similarly, the second non-SDT DU configuration can include configuration parameters, related to operations of the RRC, RLC, MAC, and/or PHY protocol layers, that the UE 102 and DU 174 use to communicate with one another while the UE 102 operates in the connected state. In some implementations, the first non-SDT DU configuration includes configuration parameters in a CellGroupConfig IE defined in 3GPP specification 38.331 v16.7.0. Similarly, the second non-SDT DU configuration includes configuration parameters in the CellGroupConfig IE defined in 3GPP specification 38.331 v16.7.0. In some implementations, the first non-SDT DU configuration and the second non-SDT DU configuration are CellGroupConfig IEs.

The events 306, 308, 310, 312, 314, 316 and 318 are collectively referred to in FIG. 3 as a non-SDT resource (re) configuration procedure 390, which can be optional.

While the UE 102 communicates with the base station 104, or after the non-SDT resource (re) configuration procedure 390 (if performed), the CU-CP 172A can determine to transition the UE 102 to an inactive state from the connected state, based on data inactivity of the UE 102 (i.e., based on the UE 102 in the connected state having no data activity with the base station 104). In some implementations, while the UE 102 communicates with the base station 104, or after the non-SDT resource (re) configuration procedure 390 (if performed), the UE 102 determines or detects data inactivity and transmits 320, to the DU 174, UE assistance information (e.g., a UEAssistanceInformation message) indicating that the UE 102 prefers or requests to transition to the inactive state with SDT configured. In turn, the DU 174 transmits 321 a UL RRC Message Transfer message including the UE assistance information to the CU-CP 172A. Thus, the CU-CP 172A can determine that the UE 102 is in data inactivity based on the UE assistance information. In other implementations, the DU 174 can perform data inactivity monitoring for the UE 102. The CU-CP 172A can transmit a CU-to-DU message (e.g., a UE Context Setup Request message or a UE Context Modification Request message) to the DU 174 to request or command the DU 174 to perform the data inactivity monitoring, for example. In cases where the DU 174 detects or determines that the UE 102 is in data inactivity during the monitoring, the DU 174 can transmit 322 an inactivity notification (e.g., a UE Inactivity Notification message) to the CU-CP 172A. Thus, the CU-CP 172A can determine that the UE 102 is in data inactivity based on the inactivity notification received from the DU 174. In yet other implementations, the CU-UP 172B can perform data inactivity monitoring for the UE 102. The CU-CP 172A can transmit a CP-to-UP message (e.g., a Bearer Context Setup Request message or a Bearer Context Modification Request message) to the CU-UP 172B to request or command the CU-UP 172B to perform the data inactivity monitoring, for example. In cases where the CU-UP 172B detects or determines that the UE 102 is in data inactivity during the monitoring, the CU-UP 172B can transmit 323 an inactivity notification (e.g., a Bearer Context Inactivity Notification message) to the CU-CP 172A. Thus, the CU-CP 172A can determine that the UE 102 is in data inactivity based on the inactivity notification received from the CU-UP 172B. In some implementations, the CU-CP 172A can determine that the UE 102 is in data inactivity based on any combination of the UE assistance information, the inactivity notification of the event 322, and/or the inactivity notification of the event 323.

After a certain period of data inactivity, the CU-CP 172A can determine that the CU 172 and the UE 102 have not transmitted any data in the downlink direction or the uplink direction, respectively, during the certain period (e.g., using any of the techniques described above for the UE inactivity determination). In response to the determination, the CU-CP 172A can determine to transition the UE 102 to the inactive state with SDT configured. Alternatively, the CU-CP 172A can determine to immediately transition the UE 102 to the inactive state with SDT configured in response to determining that the UE 102 is in data inactivity, irrespective of whether the CU 172 has transmitted data in the downlink direction in any particular time period.

In response to or after determining that the UE 102 is in data inactivity (for the certain period) or otherwise in response to determining to transition the UE 102 to the inactive state with SDT configured, the CU-CP 172A sends 324 to the CP-CU 172B a Bearer Context Modification Request message to suspend data transmission for the UE 102. In response, the CU-UP 172B suspends data transmission for the UE 102 and sends 326 a Bearer Context Modification Response message to the CU-CP 172A. Also in response to or after determining that the UE 102 is in data inactivity (for the certain period) or otherwise in response to determining to transition the UE 102 to the inactive state with SDT configured, the CU-CP 172A sends 328 a second CU-to-DU message (e.g., a UE Context Modification Request message) to instruct the DU 174 to provide (i.e., request from the DU 174) an SDT DU configuration for the UE 102. In some implementations, the CU-CP 172A can include an SDT request indication (e.g., a field or IE) to request an SDT DU configuration in the second CU-to-DU message. In response to the SDT request indication or the second CU-to-DU message, the DU 174 transmits 330 a second DU-to-CU message (e.g., UE Context Modification Response message) that includes a first SDT DU configuration to the CU-CP 172A. Alternatively, the DU 174 does not include an SDT DU configuration in the second DU-to-CU message, and the DU 174 instead sends to the CU-CP 172A another DU-to-CU message (e.g., UE Context Modification Required message) including the first SDT DU configuration, after receiving the second CU-to-DU message (event 328) and/or after transmitting the second DU-to-CU message (event 330). In some alternative implementations, the CU-CP 172A can transmit the second CU-to-DU message and receive the second DU-to-CU message (or receive the alternative DU-to-CU message discussed above) before determining that the UE 102 is in data inactivity. In other alternative implementations, the CU-CP 172A can include the SDT request indication in the first CU-to-DU message of the event 308 and the DU 174 includes the first SDT DU configuration in the first DU-to-CU message of the event 310 in response to the SDT request indication.

In response to determining to transition the UE 102 to the inactive state with SDT configured, the CU-CP 172A can generate an RRC release message (e.g., RRCRelease message or RRCConnectionRelease message) to transition the UE 102 to the inactive state. The CU-CP 172A can include the first SDT DU configuration and a first SDT CU configuration in the RRC release message. The CU-CP 172A then sends 332 to the DU 174 a third CU-to-DU message (e.g., a UE Context Release Command message or a UE Context Modification Request message) which includes the RRC release message. In turn, the DU 174 transmits 334 the RRC release message to the UE 102. The RRC release message instructs the UE 102 to transition to the inactive state. The UE 102 transitions 336 to the inactive state from the connected state upon receiving the RRC release message. In response to the third CU-to-DU message, the DU 174 can retain the first SDT DU configuration and may or may not release the first non-SDT DU configuration and/or second non-SDT DU configuration. The DU 174 can send a third DU-to-CU message (e.g., a UE Context Release Complete message or a UE Context Modification Response message) to the CU-CP 172A in response to the third CU-to-DU message.

The events 320 (optional), 321 (optional), 322 (optional), 323, 324, 326, 328, 330, 332 and 334 are collectively referred to in FIG. 3 as an SDT configuration procedure 392.

In some implementations, the UE 102 releases the first non-SDT DU configuration and/or second non-SDT DU configuration or at least a portion of the first non-SDT DU configuration and/or second non-SDT DU configuration, in response to the RRC release message. In other implementations, if the RRC release message instructs the UE 102 to transition to the inactive state (i.e., RRC_IDLE), the UE 102 releases the first non-SDT DU configuration and/or second non-SDT configuration. In yet other implementations, if the RRC release message instructs the UE to transition to the inactive state (i.e., RRC_INACTIVE), the UE 102 releases a first portion of the first and/or second non-SDT DU configurations and retains a second portion of the first and/or second non-SDT DU configurations.

In some implementations, the CU-CP 172A does not include an indication in the third CU-to-DU message to instruct the DU 174 to retain the first SDT DU configuration, but the DU 174 nonetheless retains the first SDT DU configuration as described above. In another implementation, the CU-CP 172A can include an indication in the third CU-to-DU message to instruct the DU 174 to retain the first SDT DU configuration, and the DU 174 retains the first SDT DU configuration in response to the indication. In this implementation, if the DU 174 receives from the CU-CP 172A a UE Context Release Command message for the UE 102 excluding the indication, the DU 174 releases the first SDT DU configuration. In yet another implementation, the CU-CP 172A does not include an indication in the third CU-to-DU message to instruct the DU 174 to release the first SDT DU configuration, and the DU 174 retains the first SDT DU configuration in response to the third CU-to-DU message excluding the indication. In this implementation, if the DU 174 receives from the CU-CP 172A a CU-to-DU message (e.g., a UE Context Release Command message or a UE Context Modification Request message) for the UE 102 including the indication, the DU 174 releases the first SDT DU configuration.

In some implementations, the first SDT CU configuration includes a DRB list (e.g., a std-DRB-List) including a list of DRB ID(s) indicating ID(s) of DRB(s) configured for SDT. In some implementations, the first SDT CU configuration can include a SRB2 indication (e.g., sdt-SRB2-Indication) indicating a SRB2 configured for SDT. In some implementations, the first SDT CU configuration can include a compression protocol continue indication (e.g., sdt-DRB-ContinueROHC) indicating whether a PDCP entity for the DRB(s) configured for SDT, during SDT operation (i.e., initial and/or subsequent SDT as described in FIG. 4), continues. In some implementations, the SDT CU configuration can include a data volume threshold (e.g., sdt-Data VolumeThreshold) for the UE 102 to determine whether SDT can be initiated.

In some implementations, the first SDT DU configuration can include at least one common SDT configuration, at least one RA-SDT configuration and/or at least one CG-SDT configuration for CG-SDT. For example, the at least one common SDT configuration can include a buffer status reporting (BSR) configuration and/or a power headroom reporting (PHR) configuration. In another example, the at least one RA-SDT configuration can include random access configuration parameters for two-step and/or four-step random access procedures. In another example, the at least one CG-SDT configuration includes a configured grant configuration for CG-SDT, a time alignment timer value for CG-SDT, and/or a timing advance validity threshold. The DU 174 configures the timing advance validity threshold for the UE 102 to determine whether the UE 102 can perform SDT using the configured grant configuration for CG-SDT. In accordance with the timing advance validity threshold, the UE 102 can evaluate whether a stored timing advance value is still valid. If the UE 102 determines that the stored timing advanced value is invalid, the UE 102 can perform a RA-SDT with the CU 172 via the DU 174 as described for FIG. 4.

In the case where the DU 174 provides the CG-SDT configuration to the CU-CP 172A at event 330, the DU 174 retains radio resources configured by the at least CG-SDT configuration while retaining the first SDT DU configuration. In some implementations, the DU 174 releases radio resources configured by the CG-SDT configuration when releasing the first SDT DU configuration or the CG-SDT configuration. In cases where the DU 174 does not provide the CG-SDT configuration to the CU-CP 172A, the DU 174 releases all related signaling and user data transport resources for the UE 102 in response to the third CU-to-DU message. In cases where the DU 174 provides the CG-SDT configuration to the CU-CP 172A, the DU 174 retains all related signaling and user data transport resources for the UE 102 in response to or after receiving the third CU-to-DU message.

In cases where the first SDT DU configuration does not include a configuration for CG-SDT, the CU-CP 172A and/or the DU 174 only configures RA-SDT for the UE 102. In such cases, the UE 102 can perform RA-SDT with the CU 172 via the DU 174 as described for FIG. 4.

In some implementations, the CU-CP 172A may not request the DU 174 to provide an SDT DU configuration for transitioning the UE 102 to the inactive state with SDT configured. In such cases, the events 328 and 330 can omitted, and the CU-CP 172A does not include an SDT DU configuration in the RRC release message. Instead, the CU-CP 172A may generate the first SDT DU configuration by itself without requesting the DU 174 to provide an SDT DU configuration, and include the first SDT DU configuration in the RRC release message.

In some implementations, the DU 174 may not include an SDT DU configuration in the second DU-to-CU message, e.g., if or because the UE 102 does not support CG-SDT, the DU 174 does not support CG-SDT, or the DU 174 does not have available radio resources for CG-SDT. In such cases, the RRC release message does not include an SDT DU configuration. Otherwise, the DU 174 can include the first SDT DU configuration as described above. In some implementations, the DU 174 may not include a CG-SDT configuration in the first SDT DU configuration in the second DU-to-CU message, e.g., if or because the UE 102 does not support CG-SDT, the DU 174 does not support CG-SDT, or the DU 174 does not have available radio resources for CG-SDT. In such cases, the first SDT DU configuration does not include a CG-SDT configuration. Otherwise, the DU 174 can include the at least one CG-SDT configuration in the first SDT DU configuration as described above.

In some implementations, the CU-CP 172A may request the DU 174 to provide an SDT DU configuration as described above, in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. The CU-CP 172A can receive a UE capability (e.g., UE-NR-Capability IE) of the UE 102 from the UE 102, the CN 110 (e.g., MME 114 or AMF 164) or the base station 106, while the UE operates 302 in the connected state. The UE capability indicates whether the UE 102 supports CG-SDT. Thus, the CU-CP 172A can determine whether the UE supports CG-SDT in accordance with the UE capability. In some implementations, the CU-CP 172A can receive from the DU 174 a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 may determine whether to provide an SDT DU configuration for the UE 102 to the CU-CP 172A, based on whether the UE 102 supports CG-SDT or not. In addition to whether the UE 102 supports CG-SDT or not, the DU 174 may additionally determine whether to provide an SDT DU configuration for the UE 102 to the CU-CP 172A, based on whether the DU 174 supports CG-SDT or not. In cases where the UE 102 supports CG-SDT and/or the DU 174 supports CG-SDT, the DU 174 provides the first SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the first SDT DU configuration in the second DU-to-CU message). The DU 174 can receive the UE capability from the CU-CP 172A, while the UE operates 302 in the connected state or in the inactive state before the event 302. Thus, the DU 174 can determine whether the UE supports CG-SDT in accordance with the UE capability. In some implementations, the DU 174 can send a DU-to-CU message to the CU-CP 172A to indicate whether the DU 174 does support CG-SDT or not, as described above.

Referring now to FIG. 4, a scenario 400 depicts small data transmission. In the scenario 400, the base station 104 includes a CU 172 and a DU 174. The CU 172 includes a CU-CP 172A and a CU-UP 172B. In the scenario 400, the UE 102 initially operates 402 in an inactive state with SDT configured. In some implementations or scenarios, prior to the events shown in FIG. 4, the UE 102 can transition to the inactive state with SDT configured from the connected state as described for FIG. 3 (i.e., event 402 can follow event 336). In other implementations or scenarios, prior to the events shown in FIG. 4, the UE 102 can transition to the inactive state with SDT configured from the inactive state without SDT configured. For example, the UE 102 can receive from a base station (e.g., the base station 104 or base station 106) an RRC release message transitioning the UE 102 to the inactive state and not including an SDT configuration. In this case, the UE 102 transitions to the inactive state without SDT configured in response to the RRC release message. The UE 102 in the inactive state with or without SDT configured may perform a RAN notification area (RNA) update with the base station without state transitions. During the RNA update, the UE 102 receives another RRC release message including a first SDT CU configuration and/or a first SDT DU configuration from the base station, similar to the RRC release message of the event 334.

Later in time, the UE 102 operating in the inactive state with SDT configured initiates SDT. In response to or after initiating SDT, the UE 102 generates an initial UL MAC PDU, which includes a UL RRC message and transmits 404 the initial UL MAC PDU to the DU 174 on the cell 124. The UE 102 may start an SDT timer in response to initiating the SDT. The DU 174 retrieves the UL RRC message from the initial UL MAC PDU, generates a first DU-to-CU message including the UL RRC message, and sends 406 the first DU-to-CU message to the CU-CP 172A. In some implementations, the first DU-to-CU message can be an Initial UL RRC Message Transfer message. In other implementations, the first DU-to-CU message can be a UL RRC Message Transfer message.

In scenarios in which the UE 102 initiates SDT to transmit UL data (e.g., a data packet) qualifying for SDT, the UE 102 includes the UL data in the initial UL MAC PDU that the UE 102 transmits 404. In scenarios in which the UE 102 initiates SDT to receive DL data, the UE 102 does not include an UL data packet in the initial UL MAC PDU that the UE 102 transmits 404. The UE 102 can initiate SDT to receive DL data in response to receiving a paging from the DU 174. In such scenarios, the UE 102 can include an SDT indication in the initial UL MAC PDU or the UL RRC message to indicate to the base station 104 that the UE 102 is initiating SDT to receive DL data.

In some implementations, the UE 102 can include a buffer status report or a power headroom report in the initial UL MAC PDU of the event 404. In other implementations, the UE 102 refrains from including a buffer status report and/or a power headroom report in the initial UL MAC PDU of the event 404, e.g., in accordance with the BSR configuration and/or PHR configuration, respectively. In the buffer status report, the UE 102 can include or indicate its buffer status for one or more logical channels or logical channel groups. In the power headroom report, the UE 102 can include or indicate power headroom status or value.

In some implementations, the UE 102 in the inactive state performs a random access procedure with the DU 174 to transmit 404 the UL MAC PDU. In such cases, the SDT is a RA-SDT. For example, the random access procedure can be a four-step random access procedure or a two-step random access procedure. In the case of the four-step random access procedure, the UE 102 transmits a random access preamble to the DU 174 and, in response, the DU 174 transmits to the UE 102 a random access response (RAR) including an uplink grant, and the UE 102 transmits 404 the UL MAC PDU in accordance with the uplink grant. The DU 174 receives 404 the UL MAC PDU in accordance with the uplink grant in the RAR. In the case of the two-step random access procedure, the UE 102 transmits 404 to the DU 174 a message A including a random access preamble and the UL MAC PDU in accordance with two-step random access configuration parameters. The UE 102 receives the two-step random access configuration parameters in system information broadcast by the DU 174 on the cell 124 before transmitting 404 the UL MAC PDU. The DU 174 receives 404 the UL MAC PDU in accordance with the two-step random access configuration parameters.

In further implementations, the UE 102 can transmit 404 the UL MAC PDU on radio resources configured in a configured grant (CG) configuration for SDT in cases where the UE 102 received a CG-SDT configuration as described for FIG. 3. Thus, the DU 174 receives 404 the UL MAC PDU on the radio resources. In such implementations, the UE 102 can transmit (at event 418) subsequent UL MAC PDU(s) including one or more UL data packets, discussed below, on radio resources configured in the CG configuration.

If the UE 102 includes UL data in the initial UL MAC PDU, the DU 174 retrieves the UL data from the initial UL MAC PDU. In such cases, the DU 174 can include the UL data in the DU-to-CU message of the event 406. Alternatively, the DU 174 can send the UL data to the CU-CP 172A separately, in a DU-to-CU message (i.e., event 415). In some implementations, the DU-to-CU message of event 415 can be a UL RRC Message Transfer message. As yet another alternative, the DU 174 can send 416 the UL data to the CU-UP 172B separately via a user-plane (UP) connection as described below (i.e., event 416). After receiving 406 the first DU-to-CU message, the CU-CP 172A in some implementations can send 408 a UE Context Setup Request message to the DU 174 to establish a UE Context of the UE 102 at the DU 174. In the UE Context Setup Request message, the CU-CP 172A can include transport layer information for one or more GTP-U tunnels between the CU-UP 172B and DU 174 so that the DU 174 can transmit the UL data and/or subsequent UL data (e.g., in small data communication 418) via the one or more GTP-U tunnels to the CU-UP 172B. In response, the DU 174 can send 410 a UE Context Setup Response message to the CU-CP 172A. After receiving 406 the first DU-to-CU message, transmitting 408 the UE Context Setup Request message, and/or receiving 410 the UE Context Setup Response message, the CU-CP 172A transmits 412 to the CU-UP 172B a Bearer Context Modification Request message to resume data transmission for the UE 102. In response, the CU-UP 172B resumes data transmission for the UE 102 and transmits 414 a Bearer Context Modification Response message to the CU-CP 172A. After receiving 408 the UE Context Setup Request message and/or transmitting 410 the UE Context Setup Response message, the DU 174 can transmit 415 the DU-to-CU message including the UL data to the CU-CP 172A, in cases where the UL data packet (received at the event 404) includes an RRC message or is associated with a SRB (e.g., SRB1 or SRB2). In cases where the UL data packet is associated with a DRB, the DU 174 can transmit 416 the UL data packet to the CU-UP 172B via one of the one or more GTP-U tunnels.

In some implementations, the CU-CP 172A can include transport layer information of the CU-UP 172B in the UE Context Setup Request message. The transport layer information of the CU-UP 172B can include an IP address and/or an uplink tunnel endpoint ID (e.g., TEID). The DU 174 can transmit 416 the UL data to the CU-UP 172B using the transport layer information of the CU-UP 172B. In cases where the UE 102 has subsequent UL data (e.g., one or more UL data packets) to transmit, the UE 102 can transmit (at event 418) one or more subsequent UL MAC PDUs including the subsequent UL data to the DU 174. In turn, the DU 174 retrieves the subsequent UL data from the subsequent UL MAC PDU(s). In cases where the subsequent UL data is associated with one or more SRB (e.g., SRB1 and/or SRB2), the DU 174 transmits 418 the one or more DU-to-CU messages including the subsequent UL data to the CU-CP 172A. Each DU-to-CU message can include a particular UL data packet of the subsequent UL data. In cases where the subsequent UL data is associated with one or more DRBs, the DU 174 transmits (at event 418) the subsequent UL data to the CU-UP 172B. In some implementations, the DU 174 can include DU transport layer information of the DU 174 in the UE Context Setup Response message. In turn, the CU-CP 172A can include the transport layer information of the DU 174 in the Bearer Context Modification Request message. The transport layer information of the DU 174 can include an IP address and/or a downlink TEID. In cases where the CU-UP 172B receives DL data from the CN 110 or an edge server, the CU-UP 172B can transmit 418 the DL data (e.g., one or more DL data packets) to the DU 174 using the transport layer information of the DU 174. In turn, the DU 174 transmits (at event 418) one or more DL MAC PDUs including the DL data to the UE 102 operating in the inactive state. In some implementations, the UE 102 can include a buffer status report or a power headroom report in the subsequent UL MAC PDU(s), e.g., in accordance with the BSR configuration and/or PHR configuration, respectively. In the buffer status report, the UE 102 can include or indicate its buffer status for one or more logical channels or logical channel groups. In the power headroom report, the UE 102 can include or indicate power headroom status or value.

In some example scenarios, the (subsequent) UL data and/or DL data described above include IP packet(s), an Ethernet packet(s), or an application packet(s). In other scenarios, the UL data include PDU(s) (e.g., RRC PDU(s), PDCP PDU(s) or RLC PDU(s)) that includes RRC message(s), NAS message(s), IP packet(s), Ethernet packet(s), or application packet(s).

The events 404, 406, 408, 410, 412, 414, 415 and 416 are collectively referred to in FIG. 4 as an SDT procedure 494.

In some implementations, the UL RRC message is an (existing) RRC resume request message (e.g., an RRCResumeRequest message, an RRCResumeRequest1 message, an RRCConnectionResumeRequest message, or an RRCConnectionResumeRequest1 message). In other implementations, the UL RRC message can be a new RRC resume request message, similar to the existing RRC resume request message. For example, the new RRC resume request message may be defined in future 3GPP standards documentation. The new RRC resume request message may be a format of an existing RRC resume request message. In the case of the downlink SDT, the UL RRC message can include an SDT indication, which can be a field or information element (IE) (e.g., resumeCause or ResumeCause). In some implementations, the UL RRC message is a common control channel (CCCH) message.

After the UE 102 transmits 404 the UL MAC PDU or communicates 418 the subsequent UL data and/or DL data with the DU 174, the CU-CP 172A can determine to stop the SDT for the UE 102 based on data inactivity of the UE 102 (i.e., the UE 102 in the inactive state has no data activity with the base station 104). For example, after the UE 102 transmits 404 the UL MAC PDU or communicates 418 the subsequent UL data and/or DL data with the DU 174, the UE 102 in the inactive state can determine or detect data inactivity and transmit 420 to the DU 174 UE assistance information (e.g., a UEAssistanceInformation message) indicating that the UE 102 prefers or requests to stop the SDT. In turn, the DU 174 transmits 421 a UL RRC Message Transfer message including the UE assistance information to the CU-CP 172A. Thus, the CU-CP 172A can determine that the UE 102 is in data inactivity based on the UE assistance information. In other implementations, the DU 174 can perform data inactivity monitoring for the UE 102. For example, the CU-CP 172A can transmit a CU-to-DU message (e.g., the UE Context Setup Request message of the event 408 or a UE Context Modification Request message) to the DU 174 to request or command the DU 174 to perform the data inactivity monitoring. In cases where the DU 174 detects or determines that the UE 102 is in data inactivity during the monitoring, the DU 174 can transmit 422 an inactivity notification (e.g., UE Inactivity Notification message) to the CU-CP 172A. Thus, the CU-CP 172A can determine that the UE 102 is in data inactivity based on the inactivity notification received from the DU 174. In yet other implementations, the CU-UP 172B can perform data inactivity monitoring for the UE 102. For example, the CU-CP 172A can transmit a CP-to-UP message to the CU-UP 172B to request or command the CU-UP 172B to perform the data inactivity monitoring. In some implementations, the CP-to-UP message can be a Bearer Context Setup Request message or a Bearer Context Modification Request message before the UE 102 initiates the SDT. In other implementations, the CP-to-UP message can be a Bearer Context Modification Request message during the SDT (e.g., the event 412). In cases where the CU-UP 172B detects or determines that the UE 102 is in data inactivity during the monitoring, the CU-UP 172B can transmit 423 an inactivity notification (e.g., Bearer Context Inactivity Notification message) to the CU-CP 172A. Thus, the CU-CP 172A can determine that the UE 102 is in data inactivity based on the inactivity notification received from the CU-UP 172B. In some implementations, the CU-CP 172A can determine that the UE 102 is in data inactivity based on any combination of the UE assistance information, inactivity notification of the event 422, and/or inactivity notification of the event 423.

After a certain period of data inactivity, the CU-CP 172A can determine that neither the CU 172 nor the UE 102 has transmitted any data in the downlink direction or the uplink direction, respectively, during the certain period (e.g., using any of the techniques described above for the UE inactivity determination). In response to the determination, the CU-CP 172A can determine to stop the SDT. Alternatively, the CU-CP 172A can determine to immediately stop the SDT for the UE 102 in response to determining that the UE 102 is in data inactivity, irrespective of whether the CU 172 has transmitted data in the downlink direction in any particular time period.

In response to or after determining that the UE 102 is in data inactivity (for the certain period) or otherwise determining to stop the SDT, the CU-CP 172A sends 424 to the CP-CU 172B a Bearer Context Modification Request message to suspend data transmission for the UE 102. In response, the CU-UP 172B suspends data transmission for the UE 102 and sends 426 a Bearer Context Modification Response message to the CU-CP 172A. In response to or after determining that the UE 102 is in data inactivity (for the certain period) or otherwise determining to stop SDT, the CU-CP 172A sends 428 a second CU-to-DU message (e.g., a UE Context Modification Request message) to instruct the DU 174 to provide (i.e., request from the DU 174) an SDT DU configuration for the UE 102. In some implementations, the CU-CP 172A can include an SDT request indication (e.g., a field or IE) to request an SDT DU configuration in the second CU-to-DU message. In response to the SDT request indication or the second CU-to-DU message, the DU 174 transmits 430 a second DU-to-CU message (e.g., UE Context Modification Response message) including a second SDT DU configuration to the CU-CP 172A. Alternatively, the DU 174 does not include an SDT DU configuration in the second DU-to-CU message, and the DU 174 instead sends to the CU-CP 172A another DU-to-CU message (e.g., UE Context Modification Required message) including the second SDT DU configuration, after receiving the second CU-to-DU message (event 428) and/or after transmitting the second DU-to-CU message (event 430). In some alternative implementations, the CU-CP 172A can transmit the second CU-to-DU message and receive the second DU-to-CU message (or receive the alternative DU-to-CU message discussed above), before determining that the UE 102 is in data inactivity.

In response to determining to stop the SDT, the CU-CP 172A can generate an RRC release message (e.g., RRCRelease message or RRCConnectionRelease message) to stop the SDT while maintaining the UE 102 in the inactive state. The CU-CP 172A can include the SDT DU configuration (if requested and received) and an SDT CU configuration in the RRC release message. The CU-CP 172A then sends 432 to the DU 174 a third CU-to-DU message (e.g., a UE Context Release Command message or a UE Context Modification Request message) that includes the RRC release message. In turn, the DU 174 transmits 434 the RRC release message to the UE 102. The UE 102 stops the SDT and remains in the inactive state upon receiving the RRC release message. In response to or after stopping the SDT, the UE 102 may stop the SDT timer, stop monitoring a PDCCH for SDT, and/or release a C-RNTI that the UE 102 uses to monitor a PDCCH for SDT. Alternatively, the UE 102 retains the C-RNTI. In response to the third CU-to-DU message, the DU 174 can retain the SDT DU configuration and may or may not release the first non-SDT DU configuration and/or second non-SDT DU configuration discussed above in connection with FIG. 3. The DU 174 can send a third DU-to-CU message (e.g., a UE Context Release Complete message or a UE Context Modification Response message) to the CU-CP 172A in response to the third CU-to-DU message. In some implementations, if the RRC release message instructs the UE 102 to transition to the inactive state (specifically, RRC_IDLE), the UE 102 transitions to the RRC_IDLE state and releases a non-SDT configuration (e.g., the first non-SDT DU configuration, first non-SDT CU configuration, second non-SDT DU configuration, and/or second non-SDT CU configuration described for FIG. 3) and at least one SDT configuration (e.g., the first SDT DU configuration and/or first SDT CU configuration described for FIG. 3).

Examples and implementations discussed above for events 320, 321, 322, 323, 324, 326, 328, 330, 332, 334 can apply to events 420, 421, 422, 423, 424, 426, 428, 430, 432, 434, respectively. After stopping the SDT, the UE 102 can perform another small data transmission procedure with the base station 104 or base station 106, similar to the procedure 490.

In some implementations, the CU-CP 172A may not request that the DU 174 provides an SDT DU configuration. In such cases, the events 428 and 430 can be omitted, and the CU-CP 172A does not include an SDT DU configuration in the RRC release message. Alternatively, the CU-CP 172A may generate the second SDT DU configuration by itself and include the second SDT DU configuration in the RRC release message.

In some implementations, the DU 174 may not include an SDT DU configuration in the second DU-to-CU message, e.g., if or because the UE 102 does not support CG-SDT, the DU 174 does not support CG-SDT, or the DU 174 does not have available radio resources for CG-SDT. In such cases, the RRC release message does not include an SDT DU configuration. Otherwise, the DU 174 can include the second SDT DU configuration as described above. In some implementations, the DU 174 may not include a CG-SDT configuration in the second SDT DU configuration in the second DU-to-CU message, e.g., if or because the UE 102 does not support CG-SDT, the DU 174 does not support CG-SDT or the DU 174 does not have available radio resources for CG-SDT. In such cases, the second SDT DU configuration does not include a CG-SDT configuration. Otherwise, the DU 174 can include the at least one CG-SDT configuration in the second SDT DU configuration as described above.

In some implementations, the CU-CP 172A may request the DU 174 to provide an SDT DU configuration as described above, in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. The CU-CP 172A can receive a UE capability (e.g., UE-NR-Capability IE) of the UE 102 from the UE 102, the CN 110 (e.g., MME 114 or AMF 164) or the base station 106, before the UE 102 initiated the SDT, while the UE 102 operates 402 in the inactive state, while the UE 102 performs the SDT (e.g., in the UE Context Setup Request message of the event 408 or the CU-to-DU message of the event 428), or while the UE 102 operates in the connected state as described for FIG. 3. The UE capability indicates whether the UE 102 supports CG-SDT. Thus, the CU-CP 172A can determine whether the UE 102 supports CG-SDT in accordance with the UE capability. In some implementations, the CU-CP 172A can receive from the DU 174 a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 may determine whether to provide an SDT DU configuration for the UE 102 to the CU-CP 172A, based on whether the UE 102 supports CG-SDT or not. In addition to whether the UE 102 supports CG-SDT or not, the DU 174 may additionally determine whether to provide an SDT DU configuration for the UE 102 to the CU-CP 172A, based on whether the DU 174 supports CG-SDT or not. In cases where the UE 102 supports CG-SDT and/or the DU 174 supports or enables CG-SDT, the DU 174 provides the second SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the second SDT DU configuration in the second DU-to-CU message). The DU 174 can receive the UE capability from the CU-CP 172A, e.g., while the UE 102 operates in the connected state or in the inactive state. Thus, the DU 174 can determine whether the UE 102 supports CG-SDT in accordance with the UE capability. In some implementations, the DU 174 can send a DU-to-CU message to the CU-CP 172A to indicate whether the DU 174 supports CG-SDT, as described above.

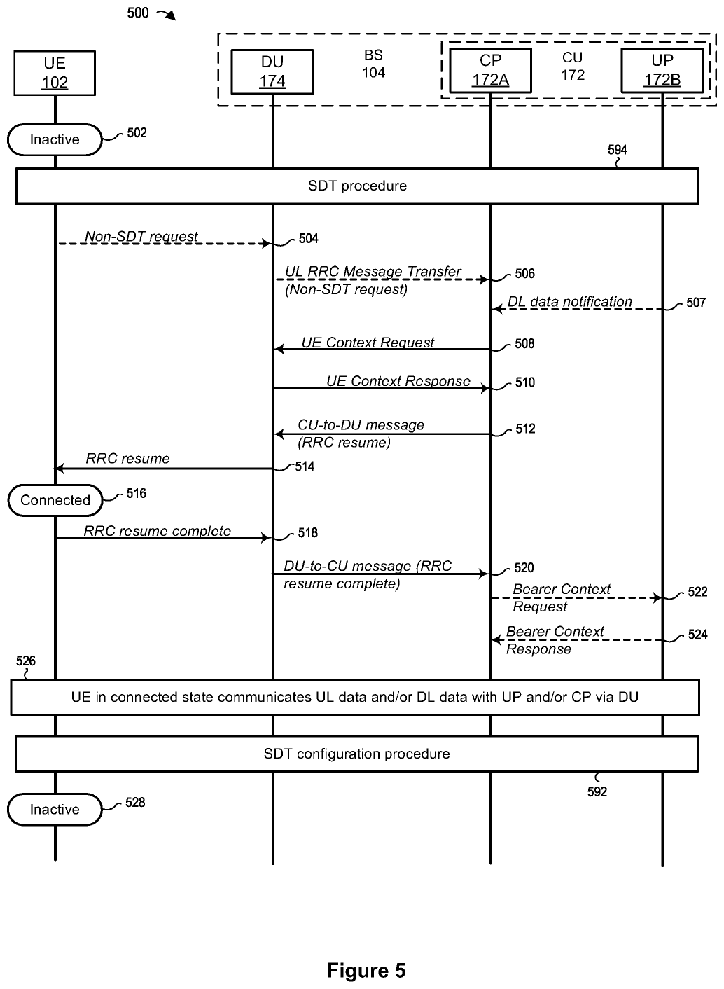

Referring now to FIG. 5, a scenario 500 depicts SDT and transitioning from SDT to non-SDT. In the scenario 500, the base station 104 includes a CU 172 and a DU 174. The CU 172 includes a CU-CP 172A and a CU-UP 172B. In the scenario 500, the UE 102 initially operates 502 in an inactive state with SDT configured, similar to the event 402. The UE 102 then performs 594 an SDT procedure with the base station 104, similar to the event 494.

During the SDT procedure 594, the CU-CP 172A can determine whether to transition the UE 102 to a connected state, e.g., based on UL or DL data activity of the UE 102. In some implementations, the UE 102 can transmit 504 to the DU 174 a non-SDT request message to request to transition to the connected state and/or indicate that UL data for non-SDT is available. In turn, the DU 174 transmits 506 a UL RRC Message Transfer message including the non-SDT request message to the CU-CP 172A. The CU-CP 172A can determine to transition the UE 102 to the connected state based on (e.g., in response to) the non-SDT request message. In other implementations, the CU-UP 172B receives DL data from the CN 110 and, in response, transmits 507 a DL data notification (e.g., DL Data Notification message) to the CU-CP 172A to indicate that DL data is available for transmission to the UE 102. The CU-CP 172A can determine to transition the UE 102 to the connected state based on (e.g., in response to) the DL data notification. In yet other implementations and/or scenarios, the CU-CP 172A determines to transition the UE 102 to the connected state based on measurement results received from the UE 102. In yet other implementations and/or scenarios, the CU-CP 172A receives DL data (e.g., NAS message(s)) from the CN 110, and determines to transition the UE 102 to the connected state in response to receiving the DL data.

In some implementations, the non-SDT request message of event 504 can be an RRC message (e.g., a UEAssistanceInformation message or a new/dedicated RRC message).

In some implementations, the UL data is associated with radio bearer(s) (e.g., SRB(s) and/or DRB(s)). For example, the UL data may include RRC message(s) or NAS message(s) associated to SRB(s). In another example, the UL data includes IP packet(s) associated with DRB(s). In some implementations, the UE 102 can include ID(s) of the radio bearer(s) in the non-SDT request message. Thus, the CU-CP 172A can determine whether to transition the UE 102 to the connected state based on the ID(s). For example, if the ID(s) includes particular ID(s), the CU-CP 172A can determine to transition the UE 102 to the connected state. Otherwise, the CU-CP 172A can determine not to transition the UE 102 to the connected state. In some implementations, the UE 102 can include data volume information of the UL data in the non-SDT request message of event 504. Thus, the CU-CP 172A can determine whether to transition the UE 102 to the connected state based on the data volume information. In one implementation, the data volume information includes a total data volume of the UL data. For example, the UE 102 can quantize or round the total data volume to a value that the UE 102 then includes in the data volume information. In another implementation, the data volume information includes a data volume for each of the radio bearer(s). For example, the UE 102 can quantize or round the data volume for each of the radio bearer(s) to a value that the UE 102 then includes in the data volume information. In some implementations and/or scenarios, if the total data volume is above a predetermined threshold, the CU-CP 172A can determine to transition the UE 102 to the connected state. Otherwise, the CU-CP 172A can determine not to transition the UE 102 to the connected state. In another example, if the data volume for a particular radio bearer is above a predetermined threshold, the CU-CP 172A can determine to transition the UE 102 to the connected state. Otherwise, the CU-CP 172A can determine not to transition the UE 102 to the connected state. In yet another example, if the total data volume is above a predetermined threshold and the data volume for a particular radio bearer is above another predetermined threshold, the CU-CP 172A can determine to transition the UE 102 to the connected state. Otherwise, the CU-CP 172A can determine not to transition the UE 102 to the connected state.

After (e.g., in response to) determining to transition the UE 102 to the connected state, the CU-CP 172A transmits 508 a UE Context Request message (e.g., a UE Context Setup Request message or a UE Context Modification Request message) to the DU 174. In response, the DU 174 transmit 510 a UE Context Response message to the CU-CP 172A. In some implementations, the DU 174 can include a non-SDT DU configuration (i.e., a first non-SDT DU configuration) in the UE Context Response message. After receiving the UE Context Response message, the CU-CP 172A transmits 512 a CU-to-DU message including an RRC resume message (e.g., an RRCResume message or an RRCConnectionResume message) to the DU 174. In turn, the DU 174 transmits 514 the RRC resume message to the UE 102. In response, the UE 102 transitions 516 to the connected state and transmits 518 an RRC resume complete message (e.g., an RRCResumeComplete message or an RRCConnectionResumeComplete message) to the DU 174. In cases where the UE Context Response message includes the non-SDT DU configuration, the CU-CP 172A includes the non-SDT DU configuration in the RRC resume message. The DU 174 transmits 520 a DU-to-CU message including the RRC resume complete message to the CU-CP 172A. After determining to transition the UE 102 to the connected state, the CU-CP 172A can transmit a 522 Bearer Context Request message (e.g., a Bearer Context Setup Request message or a Bearer Context Modification Request message) to the CU-UP 172B to indicate that the CU-UP 172B is to resume all suspended radio bearer(s) for the UE 102. In response, the CU-UP 172B resumes all suspended radio bearer(s) for the UE 102 and transmits 524 a Bearer Context Response message (e.g., a Bearer Context Setup Response message or a Bearer Context Modification Response message) to the CU CP-172A. In some implementations, the CU-CP 172A can transmit 522 the Bearer Context Request message after transmitting 508 the UE Context Request message, after receiving 510 the UE Context Response message, after transmitting 512 the CU-to-DU message, and/or after receiving 520 the DU-to-CU message.

In some implementations, the CU-CP 172A can include an indication indicating the DU 174 to generate a non-SDT configuration in the UE Context Request message of event 508, and the DU 174 includes the first non-SDT DU configuration in the UE Context Response message of event 510 in response to the indication. In other implementations, the CU-CP 172A stores a non-SDT DU configuration (i.e., a second non-SDT DU configuration) that a DU (e.g., the DU 174 or another DU or base station) used to communicate with the UE 102. The UE 102 can also store the second non-SDT DU configuration. In such cases, the CU-CP 172A includes the second non-SDT DU configuration in the UE Context Request message, and the DU 174 can includes the first non-SDT DU configuration in the UE Context Response message in response to receiving the second non-SDT DU configuration. In some implementations, the first non-SDT DU configuration augments or replaces the second non-SDT DU configuration. Examples and implementations for the first and second non-SDT DU configurations may include any of the example non-SDT DU configurations described above. In some implementations, the DU 174 can transmit an additional DU-to-CU message (e.g., a UE Context Modification Required message) including the first non-SDT DU configuration to the CU-CP 172A instead of including the first non-SDT DU configuration in the UE Context Response message of event 510.

After transitioning 516 to the connected state, the UE 102 communicates 526 UL data and/or DL data with the CU-CP 172A and/or CU-UP 172B via the DU 174. The UL data can include the UL data that triggered the UE to transmit the non-SDT request message at event 504. The UL data can also include new UL data available for transmission. The DL data can include the DL data that the CU 172 received from the CN 110 as described above. The DL data can also include new DL data that the CU 172 received from the CN 110. In cases where the RRC resume message of events 512 and 514 includes the first non-SDT DU configuration, the UE 102 communicates 526 with the DU 174 using the first non-SDT DU configuration. In cases where the second non-SDT DU configuration is not completely replaced by the first non-SDT DU configuration (i.e., the UE 102 does not release the second non-SDT DU configuration in response to the RRC resume message), the UE 102 can communicate 526 with the DU 174 using the configuration parameters in the second non-SDT DU configuration that are not augmented/replaced by the first non-SDT DU configuration.

In some implementations, the DU 174 may not provide the first non-SDT DU configuration to the CU-CP 172A in the UE Context Response message and the additional DU-to-CU message. In such cases, the RRC resume message of events 512 and 514 does not include the first non-SDT DU configuration, and the UE 102 and the DU 174 communicate 526 with one another using the second non-SDT DU configuration.

Later in time, the CU-CP 172A can perform 592 an SDT configuration procedure with the UE 102, the DU 174, and the CU-CP 172B, similar to the procedure 392. The UE 102 transitions 528 the inactive state in response to receiving an RRC release message in the procedure 592. Then, the UE 102 can initiate another SDT procedure with the base station 104 or base station 106, similar to the procedure 494 and/or 594.

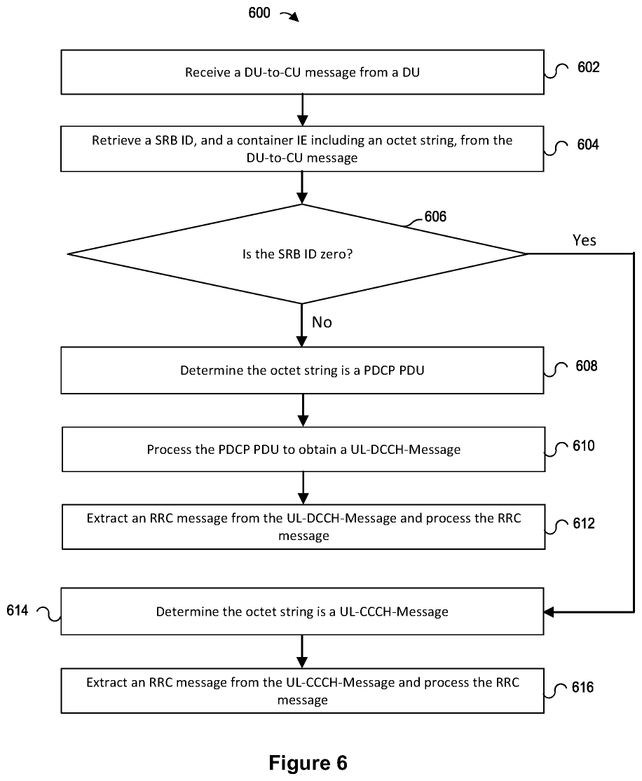

Next, several example methods, which can be implemented in a UE or a RAN (e.g., in one or more base stations, DUs, or CUs) to support data communications in the inactive state, are discussed next with reference to FIGS. 6-12.

FIG. 6 illustrates a method 600, which can be implemented by a CU (e.g., the CU 172 or CU-CP 172A) for processing an information element of an interface message to obtain an RRC message.

The method 600 generally includes determining, based on an SRB identity (ID) in a DU-to-CU message, whether an octet string in the DU-to-CU message is a PDCP PDU or a UL-CCCH message. In the example implementation shown in FIG. 6, the method 600 begins at block 602, where the CU receives a DU-to-CU message from a DU (e.g., event 321, 406, 421, 506, 520). At block 604, the CU retrieves a SRB ID and a container IE from the DU-to-CU message, where the container IE includes an octet string. At block 606, the CU determines whether the SRB ID is zero. When the CU determines the SRB ID is not zero, the flow proceeds to block 608. At block 608, the CU determines the octet string is a PDCP PDU. At block 610, the CU processes the PDCP PDU to obtain a UL-DCCH-Message. At block 612, the CU extracts an RRC message from the UL-DCCH-Message and processes the RRC message. Otherwise, when the CU at block 606 determines the SRB ID is zero, the flow proceeds to block 614. At block 614, the CU determines the octet string is a UL-CCCH-Message. At block 616, the CU extracts an RRC message from the UL-CCCH-Message and processes the RRC message.

In cases where the CU activates encryption and integrity protection for communication with the UE, the CU retrieves a PDCP sequence number, an encrypted data packet, and an encrypted MAC-I from the PDCP PDU, for example. The CU decrypts the encrypted data packet and encrypted MAC-I to obtain a data packet and a MAC-I (i.e., decrypted data packet and MAC-I), using an encryption algorithm, an encryption key (e.g., K_{RRCenc}), and encryption parameters. For example, the encryption parameters may include a LENGTH, a BEARER, a DIRECTION, and/or a COUNT. The BEARER can be the SRB ID. The COUNT can be a COUNT value of the PDCP PDU or the encrypted data packet, and is composed of the PDCP sequence number and a Hyper Frame Number (HFN). The DIRECTION can be a 1-bit value, e.g., 0. The LENGTH is a length of the encrypted data packet. The CU can perform an integrity check to verify the MAC-I using an integrity algorithm, an integrity key (e.g., KRRCint) and integrity parameters. The integrity parameters can be similar to the encryption parameters. In cases where the CU activates integrity protection for communication with the UE without activating encryption, the CU directly performs an integrity check on the data packet retrieved from the PDCP PDU as described above.

In cases where the RRC message included in the UL-CCCH-Message is an RRC resume request message (e.g., RRCResumeRequest or RRCResumeRequest1 message), the CU can retrieve a MAC-I (e.g., resumeMAC-I) from the RRC resume request message, and verifies the MAC-I using an integrity algorithm, an integrity key (e.g., KRRCint), and integrity parameters. The integrity parameters may include a BEARER, a DIRECTION, and/or a COUNT, which can be set to binary ones.

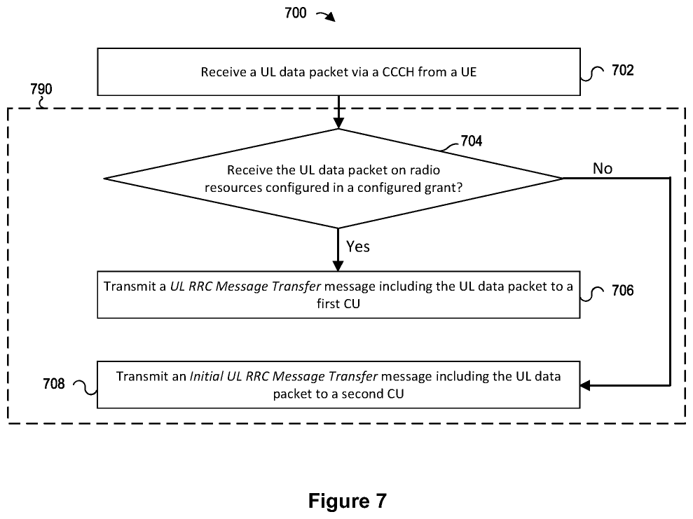

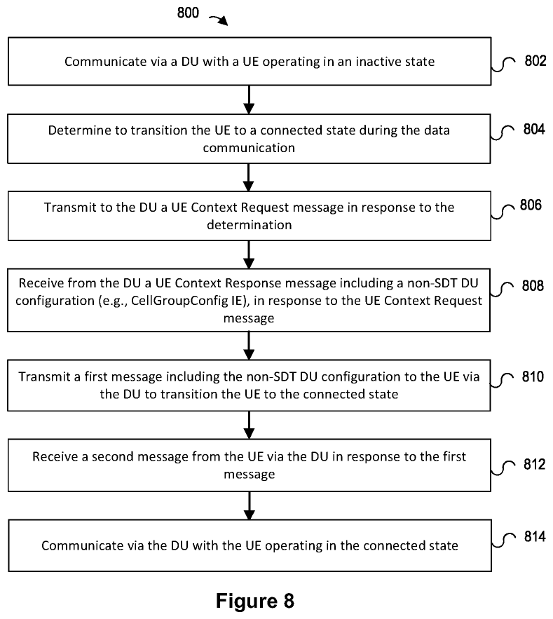

FIG. 7 illustrates a method 700, which can be implemented by a DU (e.g., the DU 174) transferring a UL data packet to a CU (e.g., the CU 172, or more specifically the CU-CP 172A).

The method 700 generally includes determining, based on whether radio resources are configured grant radio resources, whether to transmit UL data in an initial UL RRC message transfer message or a non-initial UL RRC message transfer message. In the example implementation shown in FIG. 7, the method 700 begins at block 702, where the DU receives a UL data packet via a CCCH from a UE (e.g., event 404). At block 704, the DU determines whether the DU receives the UL data packet on radio resources configured in a configured grant. When the DU determines the DU receives the UL data packet on radio resources configured in a configured grant (and thus, the previous F1 interface/connections for the UE between the DU and CU still exists), the flow proceeds to block 706. At block 706, the DU transmits a first DU-to-CU message (e.g., a UL RRC Message Transfer message) including the UL data packet to a first CU (e.g., event 406). Otherwise, when the DU determines the DU receives the UL data packet on radio resources configured in a dynamic grant, the flow proceeds to block 708. At block 708, the DU transmits an a second DU-to-CU message (e.g., an Initial UL RRC Message Transfer message, rather than the non-initial UL RRC Message Transfer message of block 706) including the UL data packet to a second CU (e.g., event 406).

The blocks 704, 706 and 708 are collectively referred to herein as an uplink transfer procedure 790.

In some implementations, the DU can receive a UL MAC PDU including a MAC subPDU from the UE. The MAC subPDU includes a logical channel ID and the uplink data packet. The logical channel ID identifies the CCCH. Therefore, the DU can determine that the uplink data packet is received via the CCCH. In some implementations, the uplink data packet can be a UL-CCCH-Message.

In some implementations, the DU can include SRB ID 0 in the UL RRC Message Transfer message and does not include the SRB ID 0 in the Initial UL RRC Message Transfer message. In some implementations, the first CU and second CU can be the same CU or CU-CP. In other implementations, the first CU and second CU can be different CUs or different CU-CPs.

In some implementations, the UE may perform a random access procedure to transmit the UL data packet and receive the dynamic grant in a random access response of the random access procedure.

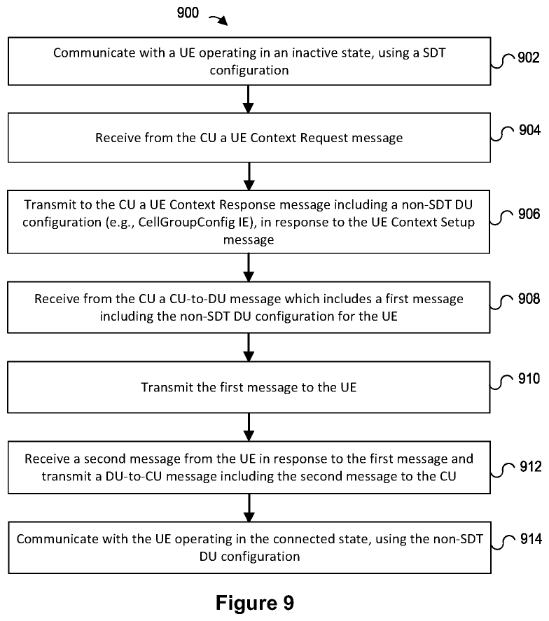

FIG. 8 illustrates a method 800, which can be implemented by a CU (e.g., the CU 172 or the CU-CP 172A) for transitioning a UE (e.g., the UE 102) to a connected state while performing small data communication with the UE operating in an inactive state.

The method 800 begins at block 802, where the CU communicates via a DU with a UE operating in an inactive state (e.g., events 404, 406, 418, 494, 594). At block 804, the CU determines to transition the UE to a connected state during the data communication. At block 806, the CU transmits to the DU a UE Context Request message in response to the determination (e.g., event 508). At block 808, in response to the UE Context Request message, the CU receives from the DU a UE Context Response message including a non-SDT DU configuration (e.g., CellGroupConfig IE) (e.g., event 510). At block 810, the CU transmits a first message including the non-SDT DU configuration to the UE via the DU to transition the UE to the connected state (e.g., event 512, 514). At block 812, the CU receives a second message from the UE via the DU in response to the first message (e.g., events 518, 520). At block 814, the CU communicates via the DU with the UE operating in the connected state (e.g., event 526).

FIG. 9 illustrates a method 900, which can be implemented by a DU (e.g., the DU 174) for transitioning a UE (e.g., the UE 102) to a connected state while performing small data communication with the UE operating in an inactive state.

The method 900 begins at block 902, where the DU communicates with a UE operating in an inactive state, using an SDT configuration (e.g., events 404, 418, 494, 594). At block 904, the DU receives from a CU a UE Context Request message (e.g., event 508). At block 906, in response to the UE Context Request message, the DU transmits to the CU a UE Context Response message including a non-SDT DU configuration (e.g., CellGroupConfig IE) (e.g., event 510). At block 908, the DU receives from the CU a CU-to-DU message which includes a first message including the non-SDT DU configuration for the UE (e.g., event 512). At block 910, the DU transmits the first message to the UE (e.g., event 514). At block 912, the DU receives a second message from the UE in response to the first message and transmits a DU-to-CU message including the second message to the CU (e.g., events 516, 518). At block 914, the DU communicates with the UE operating in the connected state using the non-SDT DU configuration (e.g., event 526).

In some implementations, the SDT configuration includes an SDT broadcast configuration (e.g., event 403) and/or an SDT DU configuration (e.g., event 330). In some implementations, the CU-to-DU message and the DU-to-CU message can be a UL RRC Message Transfer message and a DL RRC Message Transfer message, respectively. In other implementations, the CU-to-DU message and the DU-to-CU message can be F1AP messages defined in 3GPP specification 38.473.

The following implementations and examples can apply to the methods 800 and 900.

In some implementations, the CU and the UE operating in the inactive state communicates with one another (via the DU) using an SDT CU configuration and a non-SDT CU configuration. In some implementations, the first message and second message are an RRC resume message and an RRC resume complete message, respectively. More specifically, the first message and second message can be a DL-DCCH-Message and a UL-DCCH-Message including the RRC resume message and RRC resume complete message, respectively. In some implementations, the UE Context Request message and the UE Context Response message can be a UE Context Modification Request message and a UE Context Modification Response message, respectively. In other implementations, the UE Context Request message and the UE Context Response message can be a UE Context Setup Request message and a UE Context Setup Response message, respectively. In some implementations, the non-SDT DU configuration includes configuration parameter related to MAC protocol layer (e.g., NR MAC 204B) and PHY protocol layer (e.g., NR PHY 202B). After the UE transitions to the connected state, transmits the first message, and/or receives the second message, the DU communicates with the UE using the non-SDT DU configuration. In some implementations, the non-SDT DU configuration can be a CellGroupConfig IE.

In the UE Context Request message, the CU can include a first indication (e.g., an IE) indicating that the DU is to provide a non-SDT DU configuration, or indicating that the UE needs to transition to the connected state, in some implementations. In response to the first indication, the DU generates the non-SDT DU configuration and includes the non-SDT DU configuration in the UE Context Response message. In other implementations, the CU refrains from including a second indication (e.g., an IE) indicating that the DU is to provide an SDT DU configuration in the UE Context Request message. In response to the UE Context Request message excluding the second indication, the DU generates the non-SDT DU configuration and includes the non-SDT DU configuration in the UE Context Response message.

To transmit the first message to the DU or the UE via the DU, the CU can generate a downlink PDCP PDU including the first message and transmit the downlink PDCP PDU to the DU. In cases where the CU activates one or more security functions for the UE, the CU can apply the one or more security functions to the first message to obtain a first security-protected message and generate a downlink PDCP PDU including the first security-protected message, as described above. The CU can then transmit the downlink PDCP PDU to the DU. In turn, the DU generates a downlink RLC PDU including the downlink PDCP PDU and generates a downlink MAC PDU including a logical channel ID (e.g., 1) and the downlink RLC PDU. The DU can then transmit the downlink MAC PDU to the UE using the SDT configuration. Alternatively, the CU generates one or more RLC PDU segments to include the downlink PDCP PDU and generates a plurality of downlink MAC PDUs each including the logical channel ID and a particular RLC PDU segment of the one or more RLC PDU segments. The DU can then transmit the downlink MAC PDUs to the UE.

To transmit the second message to the DU, the UE can generate an uplink PDCP PDU including the second message and transmit the uplink PDCP PDU to the DU. In cases where the UE activates one or more security functions (i.e., the same as the one or more security functions applied by the CU) to communicate with the CU, the UE can apply the one or more security functions to the second message to obtain a second security-protected message, and generate a uplink PDCP PDU including the second security-protected message, as described above. The UE can then transmit the uplink PDCP PDU to the DU. More specifically, the UE can generate an uplink RLC PDU including the uplink PDCP PDU, and generate an uplink MAC PDU including the logical channel ID (e.g., 1) and the uplink RLC PDU. The UE can then transmit the uplink MAC PDU to the DU using the SDT configuration.

In some implementations, the DU continues to use the SDT configuration to communicate, e.g., data (including the downlink MAC PDU(s)) with the UE after generating the non-SDT DU configuration or transmitting the non-SDT DU configuration to the CU. The DU may stop using the SDT configuration when receiving from the CU a CU-to-DU message indicating that the DU is to do so.

In some implementations, the DU can use the non-SDT DU configuration to receive the second message from the UE. More specifically, the DU can receive the uplink MAC PDU(s) from the UE using the non-SDT DU configuration. In the non-SDT DU configuration, the DU refrains from including configuration parameters (e.g., ReconfigurationWithSync IE) causing or triggering the UE to perform a random access procedure. In some implementations, the DU can switch or determine to use the non-SDT DU configuration to communicate with the UE upon receiving at least one HARQ acknowledgement acknowledging reception of the downlink MAC PDU(s) from the UE. In such cases, the DU can stop using the SDT configuration to communicate with the UE upon receiving the at least one HARQ acknowledgement. In other implementations, the DU can switch to or determine to use the non-SDT DU configuration upon receiving from the UE at least one RLC acknowledgement acknowledging reception of the uplink RLC PDU or uplink RLC PDU segment(s). In such cases, the DU can stop using the SDT configuration to communicate with the UE upon receiving the at least one RLC acknowledgement.

In other implementations, the DU can use the SDT configuration to receive the second message from the UE. More specifically, the DU can receive the uplink MAC PDU(s) from the UE using the SDT configuration. In other words, the UE transmits the second message or the uplink MAC PDU(s) to the DU using the SDT configuration. In some implementations, the DU can switch to or determine to use the non-SDT DU configuration to communicate with the UE upon receiving the uplink MAC PDU(s) from the UE. In such cases, the DU can stop using the SDT configuration to communicate with the UE upon receiving the uplink MAC PDU(s). In some implementations, the DU may release the SDT DU configuration after (e.g., in response to) receiving the CU-to-DU message including the first message or otherwise indicating that the DU is to stop using or release the SDT DU configuration. In such cases, the CU may release the SDT CU configuration in response to transitioning the UE to the connected state. Similarly, the UE may release or stop using the SDT DU configuration and/or the SDT CU configuration after (e.g., in response to) receiving the first message. In some implementations, the DU may retain the SDT DU configuration after (e.g., in response to) receiving the CU-to-DU message or while the UE operates in the connected state. In such cases, the CU may retain the SDT CU configuration while communicating with the UE operating in the connected state. Similarly, the UE may retain the SDT DU configuration and/or the SDT CU configuration, after (e.g., in response to) receiving the first message or while operating in the connected state.

In some implementations, the DU can configure the non-SDT DU configuration to include configuration parameter(s) in the SDT configuration. For example, the configuration parameter(s) may include a PDCCH configuration, a control resource set, and/or a search space configuration for the UE to receive control signals such as downlink control information (DCIs) on one or more PDCCHs. Thus, there is no hard switching point for the DU to switch from the SDT configuration to the non-SDT DU configuration. In some implementations, the non-SDT DU configuration includes additional configuration parameters(s) not in the SDT configuration. In some implementations, the DU can apply or start to apply the additional configuration parameter(s) after generating the non-SDT DU configuration and/or after transmitting the non-SDT DU configuration to the CU. In other implementations, the DU can apply or start to apply the additional configuration parameter(s) before, during, or after transmitting the downlink MAC PDU(s). For example, the non-SDT DU configuration can include one or more RS configuration(s) (e.g., CSI-RS configuration(s)). The DU can transmit or start to transmit RS(s) in accordance with the CSI-RS configuration, after generating the non-SDT DU configuration or after transmitting the non-SDT DU configuration to the CU. Alternatively, The DU can transmit or start to transmit RS(s) in accordance with the CSI-RS configuration, before, during, or after transmitting the downlink MAC PDU(s).

In some implementations, the DU may not comprehend the first message or the downlink PDCP PDU received in the CU-to-DU message. In such cases, the CU can include an indication in the CU-to-DU message to indicate that the UE is going to transition to the connected state because of the first message (or because of the downlink PDCP PDU). Thus, the DU can prepare itself to apply the non-SDT DU configuration (i.e., a first non-SDT DU configuration) in response to the indication.

In some implementations, the CU can include another non-SDT DU configuration (i.e., a second non-SDT DU configuration) in the UE Context Request message, and the DU uses the second non-SDT DU configuration to communicate with the UE operating in the connected state before the UE transitions to the inactive state. Similarly, the UE operating in the connected state communicates with the DU using the second non-SDT DU configuration, and communicates with the CU using the non-SDT CU configuration via the DU. The second non-SDT DU configuration includes a plurality of configuration parameters related to RRC, RLC, MAC, and/or PHY protocol layers (e.g., RRC 214, NR RLC 206B, NR MAC 204B and/or NR PHY 202B). In some implementations, the second non-SDT DU configuration can be or include a CellGroupConfig IE or configuration parameters in the CellGroupConfig IE. In some implementations, the DU can generate the first non-SDT DU configuration to augment the second non-SDT DU configuration. In such cases, the DU at block 912 may communicate with the UE operating in the connected state using the configuration parameters in the first non-SDT DU configuration and/or the second non-SDT DU configuration. In other implementations, the DU can generate the first non-SDT DU configuration to replace the second non-SDT DU configuration. In yet other implementations, the DU can determine to use the second non-SDT DU configuration to communicate with the UE without generating a non-SDT DU configuration. In such cases, the DU may not include a non-SDT DU configuration in the UE Context Response message. After transmitting the first message to the UE, the DU communicates with the UE operating in the connected state using the second non-SDT DU configuration.

In some implementations, the CU can transmit to the DU another CU-to-DU message (i.e., a second CU-to-DU message) to command the DU to release the SDT DU configuration after transitioning the UE to the connected state. In response to the second CU-to-DU message, the DU releases the SDT DU configuration and may transmit a second DU-to-CU message to the CU. In the second CU-to-DU message, the CU can include a release indication indicating that the DU is to release the SDT DU configuration. In some implementations, the second CU-to-DU message and the second DU-to-CU message can be a UE Context Modification Request message and a UE Context Modification Response message, respectively. In other implementations, the second CU-to-DU message and the second DU-to-CU message can be a UE Context Release Command message and a UE Context Release Complete message, respectively.

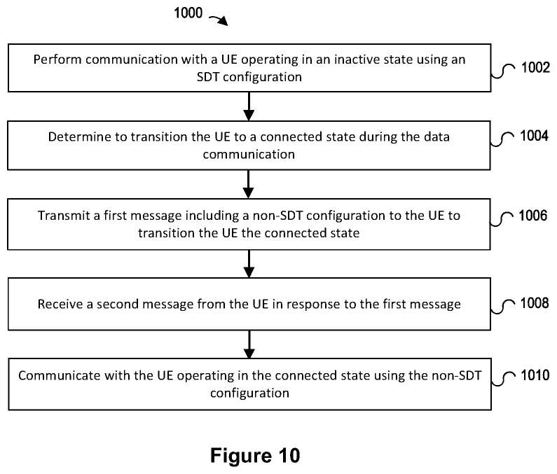

FIG. 10 illustrates a method 1000, which can be implemented by a base station (e.g., the base station 104 or 106), for transitioning a UE (e.g., the UE 102) to a connected state while performing small data communication with the UE operating in an inactive state.

The method 1000 begins at block 1002, where the base station communicates with a UE operating in an inactive state using an SDT configuration (e.g., events 404, 406, 418, 494, 594). At block 1004, the base station determines to transition the UE to a connected state during the data communication. At block 1006, the base station transmits a first message including a non-SDT configuration (e.g., a non-SDT DU configuration, if the base station is a distributed base station) to the UE to transition the UE the connected state (e.g., events 512, 514). At block 1008, the base station receives a second message from the UE in response to the first message (e.g., events 518, 520). At block 1010, the base station communicates with the UE operating in the connected state using the non-SDT (e.g., non-SDT DU) configuration (e.g., event 526).

The base station can include functions of a DU and a CU, and the implementations and examples described above for FIGS. 8 and 9 can apply to the method 1000 of FIG. 10. The SDT configuration can include an SDT broadcast configuration, an SDT DU configuration, and/or an SDT CU configuration as described above. In cases where the first message is an RRC resume message, the base station in some implementations can retain the SDT CU configuration and/or SDT DU configuration for the UE operating in the connected state as described above. In cases where the first message is an RRC setup message, the base station in some implementations can release the SDT CU configuration and/or SDT DU configuration for the UE operating in the connected state as described above. In such cases, the second message can be an RRC setup complete message.

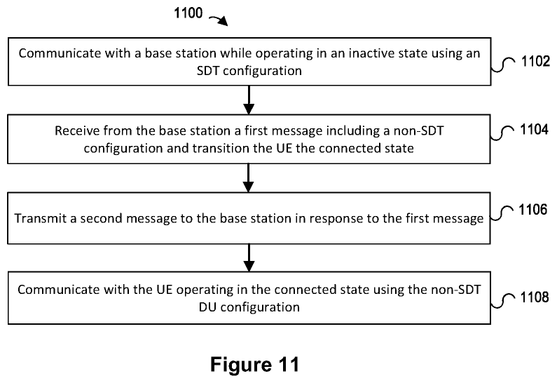

FIG. 11 illustrates a method 1100, which can be implemented by a UE (e.g., the UE 102), for transitioning to a connected state while the UE in the inactive state performs small data communication with a base station.

The method 1100 begins at block 1102, where the UE communicates with a base station while operating in an inactive state using an SDT configuration (e.g., events 404, 406, 418, 494, 594). At block 1104, the UE receives from the base station a first message including a non-SDT configuration and transitioning the UE to the connected state (e.g., event 512). At block 1106, the UE transmits a second message to the base station in response to the first message (e.g., event 518). At block 1108, the UE communicates with the UE operating in the connected state using the non-SDT DU configuration (e.g., event 526).

The base station can include functions of a DU and a CU, and the implementations and examples described above for FIGS. 8 and 9 can apply to the method 1100 of FIG. 11. The SDT configuration can include an SDT broadcast configuration, an SDT DU configuration, and/or an SDT CU configuration as described above. In cases where the first message is an RRC resume message, the UE in some implementations can retain the SDT CU configuration and/or SDT DU configuration while operating in the connected state as described above. In cases where the first message is an RRC setup message (e.g., RRCSetup message), the UE in some implementations can release the SDT CU configuration and/or SDT DU configuration while operating in the connected state as described above. In such cases, the second message can be an RRC setup complete message (e.g., RRCSetupComplete message).

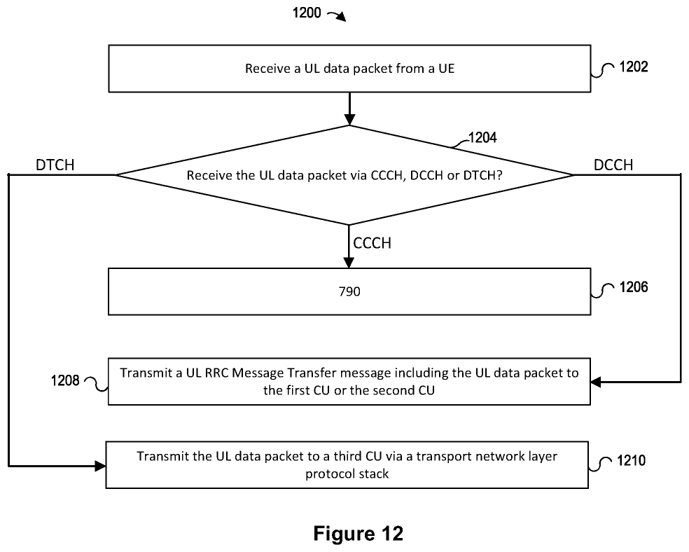

FIG. 12 illustrates a method 1200, which can be implemented by a DU (e.g., the DU 174) transferring a UL data packet to a CU (e.g., the CU 172, the CU-CP 172A).

The method 1200 generally includes determining, based on a logical channel, whether to transmit uplink data via a transport network layer protocol stack or in a UL RRC message transfer message. In the example implementation shown in FIG. 12, the method 1200 begins at block 1202, where the DU receives a UL data packet from a UE. At block 1204, the DU determines whether it receives the UL data packet via a CCCH, Dedicated Control Channel (DCCH), or Dedicated Traffic Channel (DTCH). The flow proceeds to block 1206, 1208, or 1210 when the DU determines that the DU received the UL data packet via a CCCH, DCCH, or DTCH, respectively. At block 1206, the flow proceeds to the uplink transfer procedure 790 described for FIG. 7. At block 1208, the DU transmits a UL RRC Message Transfer message including the UL data packet to the first CU or the second CU. At block 1210, the DU transmits the UL data packet to a third CU via a transport network layer protocol stack.

In some implementations, the DU can receive a UL MAC PDU including a MAC subPDU from the UE. The MAC subPDU includes a logical channel ID and the uplink data packet. The logical channel ID identifies the CCCH, DCCH, or DTCH. Therefore, the DU can determine that the uplink data packet is received via the CCCH, DCCH, or DTCH, in accordance with the logical channel ID. In the case of the CCCH, the uplink data packet can be a UL-CCCH-Message. In the case of the DCCH, the uplink data packet can be a PDCP PDU including a UL-DCCH-Message and a MAC-I. In the case of the DTCH, the uplink data packet can be a PDCP PDU including an application data packet. In some implementations, the application data packet can be an IP packet or an Ethernet packet.

In some implementations, the DU can include SRB ID 1 or SRB ID 2 in the UL RRC Message Transfer message in the block 1208. In cases where the logical channel ID is a first value (e.g., 1), the DU can include the SRB ID 1 in the UL RRC Message Transfer message in the block 1208. In cases where the logical channel ID is a first value (e.g., 2), the DU can include the SRB ID 2 in the UL RRC Message Transfer message in the block 1208. In some implementations, the first CU and second CU can be the same CU or CU-CP. In other implementations, the first CU and second CU can be different CUs or different CU-CPs. In some implementations, the third CU can be the same as or different from the first CU and/or the second CU. In other implementations, the third CU can be a CU-UP.

In some implementations, the transport network layer protocol stack includes a physical layer, a data link layer, an IP protocol, a UDP protocol, and/or a GTP-U protocol.

The following list of examples reflects a variety of the implementations explicitly contemplated by the present disclosure:
Example 1. A method, implemented by a radio access network (RAN) node, for transitioning from small data transmission (SDT) to non-SDT with a user equipment (UE), the method comprising: communicating with the UE in accordance with an SDT configuration while the UE is in an inactive state; performing a UE context procedure to obtain a non-SDT configuration; transmitting the non-SDT configuration to the UE; and communicating with the UE in accordance with the non-SDT configuration while the UE is in a connected state.
Example 2. The method of example 1, wherein: the RAN node is a central unit (CU) of a base station; and communicating with the UE in accordance with the SDT configuration, transmitting the non-SDT configuration to the UE, and communicating with the UE in accordance with the non-SDT configuration are performed via a distributed unit (DU) of the base station.
Example 3. The method of example 2, further comprising: determining to transition the UE to the connected state, wherein performing the UE context procedure is in response to the determining.
Example 4. The method of example 3, further comprising: receiving a message from the UE via the DU, wherein the determining is in response to the message.
Example 5. The method of example 4, wherein the message indicates that uplink data for non-SDT is available.
Example 6. The method of example 3, further comprising: receiving downlink data from a core network, wherein the determining is in response to receiving the downlink data.
Example 7. The method of example 6, wherein: receiving the downlink data includes receiving the downlink data at a user plane of the CU (CU-UP); the method further comprises, in response to receiving the downlink data at the CU-UP, transmitting a downlink data notification from the CU-UP to a control plane of the CU (CU-CP); and the determining is in response to the downlink data notification.
Example 8. The method of example 7, wherein receiving the downlink data includes receiving the downlink data at a control plane of the CU (CU-CP).
Example 9. The method of example 3, further comprising: receiving measurement results from the UE via the DU, wherein the determining is based on the measurement results.
Example 10. The method of any one of examples 2-9, wherein the non-SDT configuration is a non-SDT DU configuration, and wherein the performing includes: transmitting a UE context modification request message to the DU; and receiving from the DU a UE context modification response message that includes the non-SDT DU configuration.
Example 11. The method of example 1, wherein the RAN node is a distributed unit (DU) of a base station.
Example 12. The method of example 11, wherein the non-SDT configuration is a non-SDT DU configuration, and wherein the performing includes: receiving a UE context modification request message from a central unit (CU) of the base station; and transmitting to the CU a UE context modification response message that includes the non-SDT DU configuration.
Example 13. The method of example 12, wherein transmitting the non-SDT DU configuration to the UE includes: transmitting to the UE a radio resource control (RRC) resume message that includes the non-SDT DU configuration and causes the UE to transition to the connected state.
Example 14. A method, implemented by a central unit (CU) of a base station, for obtaining a radio resource control (RRC) message from an interface message, the method comprising: receiving, from a distributed unit (DU) of the base station, a DU-to-CU message that includes a signal radio bearer (SRB) identifier and an octet string; determining, based on the SRB identifier, whether the octet string is a packet data convergence protocol (PDCP) protocol data unit (PDU) or an uplink common control channel (UL-CCCH) message; and processing, based on the determining, the PDCP PDU or the UL-CCCH to obtain the RRC message.
Example 15. The method of example 14, wherein: the determining includes determining that the octet string is a PDCP PDU; and the processing includes processing the PDCP PDU to obtain an uplink dedicated control channel (UL-DCCH) message, and extracting the RRC message from the UL-DCCH message.
Example 16. The method of example 15, wherein processing the PDCP PDU includes retrieving an encrypted data packet from the PDCP PDU, and decrypting the encrypted data packet.
Example 17. The method of example 14, wherein: the determining includes determining that the octet string is a UL-CCCH; and the processing includes extracting the RRC message from the UL-CCCH.
Example 18. The method of example 17, wherein the RRC message is an RRC resume request message, and wherein the method further includes: retrieving a message authentication code for integrity (MAC-I) from the RRC resume request message; and verifying the MAC-I using an integrity algorithm, an integrity key, and integrity parameters.
Example 19. A method, implemented by a distributed unit (DU) of a base station, for transferring uplink data to a central unit (CU), the method comprising: receiving, from a user equipment (UE) in an inactive state, the uplink data via a logical channel; determining, based on the logical channel, whether to transmit the uplink data via a transport network layer protocol stack or in an uplink radio resource control (RRC) message transfer message; and transmitting the uplink data to the CU in accordance with the determining.
Example 20. The method of example 19, wherein the determining includes: when the logical channel is a dedicated traffic channel (DTCH), determining to transmit the uplink data via the transport network layer protocol stack.
Example 21. The method of example 19 or 20, wherein the determining includes: when the logical channel is a dedicated control channel (DCCH), determining to transmit the uplink data in a non-initial uplink RRC message transfer message.
Example 22. The method of any one of examples 19-21, wherein the determining includes: when the logical channel is a common control channel (CCCH) and the receiving occurs via configured grant radio resources, determining to transmit the uplink data in a non-initial uplink RRC message transfer message; and when the logical channel is a CCCH and the receiving does not occur via configured grant radio resources, determining to transmit the uplink data in an initial uplink RRC message transfer message.
Example 23. A method, implemented by a distributed unit (DU) of a base station, for transferring uplink data to a central unit (CU), the method comprising: receiving, from a user equipment (UE) in an inactive state, the uplink data via radio resources; determining, based on whether the radio resources are configured grant radio resources, whether to transmit the uplink data in an initial uplink radio resource control (RRC) message transfer message or a non-initial uplink RRC message transfer message; and transmitting the uplink data to the CU in accordance with the determining.
Example 24. The method of example 23, wherein the receiving occurs via a common control channel (CCCH).
Example 25. The method of example 24, wherein: receiving the uplink data includes receiving an uplink medium access control (MAC) protocol data unit (PDU) that includes a logical channel identifier and an uplink data packet that includes the uplink data; and the method further comprises, before determining whether to transmit the uplink data via the uplink RRC message transfer message or the non-initial uplink RRC message transfer message, determining that the uplink data packet is received via the CCCH.
Example 26. The method of any one of examples 23-25, wherein the transmitting includes: when transmitting the uplink data in the non-initial uplink RRC message transfer message, including a signal radio bearer (SRB) identifier of zero in the non-initial uplink RRC message transfer message; and when transmitting the uplink data in the initial uplink RRC message transfer message, refraining from including the SRB identifier of zero in the initial uplink RRC message transfer message.
Example 27.A radio access network (RAN) node comprising processing hardware and configured to perform the method of any one of examples 1-26.

The following description may be applied to the description above.

In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “small data transmission” can be replaced by “early data transmission (EDT)” and “SDT” can be replaced by “EDT”, and vice versa. In some implementations, “small data transmission” can be replaced by “small data communication”, and vice versa. In some implementations, “stop” can be replaced by “suspend.”

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, implemented by a distributed unit (DU) of a base station, for transferring uplink data that includes control plane or non-control plane information to a central unit (CU), the method comprising:
receiving, from a user equipment (UE) in an inactive state, the uplink data via a logical channel;
determining, based on the logical channel, whether to transmit the uplink data via a transport network layer protocol stack or in an uplink radio resource control (RRC) message transfer message; and
transmitting the uplink data to the CU in accordance with the determining.

2. The method of claim 1, wherein the determining includes:
when the logical channel is a dedicated traffic channel (DTCH), determining to transmit the uplink data via the transport network layer protocol stack.

3. The method of claim 1, wherein the determining includes:
when the logical channel is a dedicated control channel (DCCH), determining to transmit the uplink data in a non-initial uplink RRC message transfer message.

4. The method of claim 1, wherein the determining includes:
when the logical channel is a common control channel (CCCH) and the receiving occurs via configured grant radio resources, determining to transmit the uplink data in a non-initial uplink RRC message transfer message; and
when the logical channel is a CCCH and the receiving does not occur via configured grant radio resources, determining to transmit the uplink data in an initial uplink RRC message transfer message.

5. A method, implemented by a central unit (CU) of a base station, for obtaining a radio resource control (RRC) message from an interface message, the method comprising:
receiving, from a distributed unit (DU) of the base station, a DU-to-CU message that includes a signal radio bearer (SRB) identifier and an octet string;
determining, based on the SRB identifier, whether the octet string is a packet data convergence protocol (PDCP) protocol data unit (PDU) or an uplink common control channel (UL-CCCH) message; and
processing, based on the determining, the PDCP PDU or the UL-CCCH message to obtain the RRC message.

6. The method of claim 5, wherein:
the determining includes determining that the octet string is a PDCP PDU; and
the processing includes processing the PDCP PDU to obtain an uplink dedicated control channel (UL-DCCH) message, and extracting the RRC message from the UL-DCCH message.

7. The method of claim 6, wherein processing the PDCP PDU includes retrieving an encrypted data packet from the PDCP PDU, and decrypting the encrypted data packet.

8. The method of claim 5, wherein:
The determining includes determining that the octet string is a UL-CCCH message; and
the processing includes extracting the RRC message from the UL-CCCH message.

9. The method of claim 8, wherein the RRC message is an RRC resume request message, and wherein the method further includes:
retrieving a message authentication code for integrity (MAC-I) from the RRC resume request message; and
verifying the MAC-I using an integrity algorithm, an integrity key, and integrity parameters.

10. A method, implemented by a distributed unit (DU) of a base station, for transferring uplink data that includes control plane or non-control plane information to a central unit (CU), the method comprising:
receiving, from a user equipment (UE) in an inactive state, the uplink data via radio resources;
determining, based on whether the radio resources are configured grant radio resources, whether to transmit the uplink data in an initial uplink radio resource control (RRC) message transfer message or a non-initial uplink RRC message transfer message; and
transmitting the uplink data to the CU in accordance with the determining.

11. The method of claim 10, wherein the receiving occurs via a common control channel (CCCH).

12. The method of claim 11, wherein:
receiving the uplink data includes receiving an uplink medium access control (MAC) protocol data unit (PDU) that includes a logical channel identifier and an uplink data packet that includes the uplink data; and
the method further comprises, before determining whether to transmit the uplink data via the uplink RRC message transfer message or the non-initial uplink RRC message transfer message, determining that the uplink data packet is received via the CCCH.

13. The method of claim 10, wherein the transmitting includes:
when transmitting the uplink data in the non-initial uplink RRC message transfer message, including a signal radio bearer (SRB) identifier of zero in the non-initial uplink RRC message transfer message; and
when transmitting the uplink data in the initial uplink RRC message transfer message, refraining from including the SRB identifier of zero in the initial uplink RRC message transfer message.

14. A distributed unit (DU) of a base station comprising processing hardware and configured to:
receive, from a user equipment (UE) in an inactive state, uplink data that includes control plane or non-control plane information via a logical channel;
determine, based on the logical channel, whether to transmit the uplink data via a transport network layer protocol stack or in an uplink radio resource control (RRC) message transfer message; and
transmit the uplink data to a central unit (CU) of the base station in accordance with the determination of whether to transmit the uplink data via the transport network layer protocol stack or in the uplink RRC message transfer message.

15. The DU of claim 14, wherein to determine whether to transmit the uplink data via a transport network layer protocol stack or in an uplink RRC message transfer message, the DU is configured to:
when the logical channel is a dedicated traffic channel (DTCH), determine to transmit the uplink data via the transport network layer protocol stack.

16. The DU of claim 14, wherein to determine whether to transmit the uplink data via a transport network layer protocol stack or in an uplink RRC message transfer message, the DU is configured to:
when the logical channel is a dedicated control channel (DCCH), determine to transmit the uplink data in a non-initial uplink RRC message transfer message.

17. The DU of claim 14, wherein to determine whether to transmit the uplink data via a transport network layer protocol stack or in an uplink RRC message transfer message, the DU is configured to:
when the logical channel is a common control channel (CCCH) and the uplink data is received via configured grant radio resources, determine to transmit the uplink data in a non-initial uplink RRC message transfer message; and
when the logical channel is a CCCH and the uplink data is not received via configured grant radio resources, determine to transmit the uplink data in an initial uplink RRC message transfer message.
